(19) United States
(12) Patent Application Publication
(10) Pub. No.: US 2022/0153605 A1
(43) Pub. Date: May 19, 2022

(54) Mesomorphic Ceramics Films via Blade Coating of Nanorod Suspensions for High-Power Laser Applications

(71) Applicant: University of Rochester, Rochester, NY (US)

(72) Inventors: Shaw H. CHEN, Rochester, NY (US); Mitchell Anthamatten, Rochester, NY (US)

(21) Appl. No.: 17/504,841

(22) Filed: Oct. 19, 2021

Related U.S. Application Data
(60) Provisional application No. 63/093,639, filed on Oct. 19, 2020.

(51) Int. Cl. C01G 23/08; G02B 5/30; C01B 25/37; C01G 9/02; C01F 11/18

(52) U.S. Cl. CPC C01G 23/08; G02B 5/3083; B82Y 40/00; C01G 9/02; C01F 11/185; C01B 25/37

(57) ABSTRACT

Mesomorphic ceramic films are fabricated over large areas by blade-coating of nematic lyotropic suspensions, followed by calcination. Lyotropic self-assembly of titania or ZnO nanorods by applying blade-coating shear force to a dispersion of the rods, followed by thermal treatment forms transparent ceramic films for applications such as large aperture inorganic waveplates for modifying the polarization state of incident light that have superior optical and mechanical properties

### REFERENCE TO RELATED APPLICATIONS

This application claims priority to U.S. Provisional Patent Application Ser. No. 63/093,639 filed on Oct. 19, 2020 and incorporates by reference the contents thereof.

### FIELD

This patent specification relates to optical devices comprising mesomorphic ceramics useful for devices such as waveplates and methods of making such ceramics.

### BACKGROUND

Large aperture, ceramic-based waveplates that can withstand high laser fluences are demanded for satellite imaging, biological imaging, beam isolation, and power attenuation. Such waveplates are challenging to fabricate because they require precise optical retardance over large areas. Waveplates made from quartz or calcite are appealing due to their high laser-induced damage thresholds, but they are costly because they must be precisely machined from large, single crystals. In contrast, mesomorphic ceramics are anisotropic polycrystalline solids with morphologies intermediate between isotropic materials and single crystals such as sculptured inorganic thin films fabricated via glancing angle deposition (GLAD). However, GLAD is limited by defect control and thus is limited to small areas. Soft materials like polymers and liquid crystals can be inexpensively processed into large area waveplates; however, they lack the thermal stability and photostability desired for high power laser applications. Thus, there is a standing need for cost-effective, inorganic waveplates with quality surface finish over large areas.

A waveplate, also called a retarder, is an optical element that is used to modify the polarization state of incident light. A transmissive waveplate is a flat, transparent component with in-plane birefringence that retards one component of polarization relative to its orthogonal component.

Polymer waveplates are low cost and comprise stretched polymer sheets that can be laminated between glass windows. They can be made for large aperture components with low dispersion and low sensitivity to incidence angle. However, polymer waveplates have low damage threshold, and they are generally unsuitable for applications at high laser power or under high temperatures.

Inorganic waveplates offer superior stability including high damage thresholds and retardation stability over a broad temperature range. Inorganic waveplates typically are fabricated from quartz or calcite, and their aperture size generally is limited to between 70 mm and 150 mm by the crystal growth technology. Quartz waveplates are expensive because they must be cut to precise dimensions at precise angles from single crystals followed by optical polishing.

Applications for large aperture inorganic waveplates with high stability include (i) military applications for communication, satellite imaging, and directed energy weapons; (ii) high end projectors for display applications; (iii) biological imaging; and (iv) power attenuation and isolation of high power lasers.

Liquid crystals have become important materials for polarization control devices such as circular polarizers, wave-plates, laser beam shapers, and polarization smoothers. To improve the environmental durability and device robustness, glassy liquid crystals have emerged as a superior materials class via vitrification of liquid crystals below their glass transition temperatures without altering morphology. Uniaxially oriented nematic and helically stacked chiral-nematic (i.e. cholesteric) liquid crystals consisting of rod-like moieties are of important for device performance including optical birefringence, circular dichroism, and dissymmetry factor of emission. From a practical standpoint, glassy liquid crystals have furnished the benchmarks for passive polarization devices, such as non-absorbing circular polarizers, notch filters and reflectors, leaving much to be desired for use as lasers. While the challenges of laser-induced materials damage of glassy liquid crystals are being addressed for mitigation, mesomorphic ceramics have been pursued via Glancing Angle Deposition, GLAD, with limited success in achieving the desired optical quality and process scale-up. Furthermore, the GLAD approach produces helical coils as the basis for circular polarization, and GLAD films exhibit circularly polarized photoluminescence with chiroptical effects that are far inferior to the helical stack underlying chiral-nematic liquid crystal films.

In the text below, reference numerals in superscript refer to citations that are fully identified at the end of the specification and are hereby incorporated by reference in this specification. The Fist Group of references listed at the end of the specification pertains to paragraphs up to paragraph 63 in this specification and the Second Group pertains to paragraphs starting with paragraph 63.

Since their invention in the 1960s, lasers have served diverse technologies, many of which benefit from polarization control, beam shaping, and polarization smoothing that underlie laser-based devices for optical communications,¹⁻³ laser power scaling,⁴ and biological and medical imaging,^{5, 6} to name a few. With the ease of device scale-up at affordable costs, liquid crystal devices have become essential for polarization control, including circular and linear polarizers, and waveplates, using in particular cholesteric and nematic classes that are readily processed into large-area defect-free films. To improve device robustness with morphological stability against crystallization spanning decades, glassy liquid crystals emerged as a superior material class in the early 1990s via vitrification of liquid crystals below their glass transition temperatures without altering morphology.^{7, 8} Various device concepts have been successfully tested using selected materials, including non-absorbing polarizers, notch filters and reflectors, polarized electroluminescence, and solid-state lasers, all showing desirable performance levels. Simultaneously, sculptured thin film devices have been explored by glancing angle deposition (GLAD) to further improve optical device robustness.^{9, 10} Additional transparent, ceramic-based materials have also emerged, attracting attention for their high laser damage resistance.^{11, 12}

### SUMMARY OF THE DISCLOSURE

Defined as solid-state systems with liquid-crystal-like superstructures and optical properties, mesomorphic ceramics are inorganic, polycrystalline materials synthesized by spontaneous assembly of nanorods forming lyotropic liquid crystals in an isotropic, volatile solvent. For example, a lyotropic dispersion of ligand-capped anatase nanorods at 60 wt % in chlorobenzene can be calcined and sintered together to form an optically anisotropic, 2.3±0.3 micrometer thick solid film. During sintering, nanorods fuse into low aspect ratio grains that form nematic domains. Shear-induced alignment of nanorods followed by thermal treatment creates uniaxial orientation across millimeters that exhibits high optical transparency and nearly constant birefringence of 0.018±0.002 from 650 to 1700 nm. Distinct from liquid-crystal templating, this novel approach yields superstructures of nanoparticles with relative ease and at lower costs to serve, for example, as toward robust, ceramic-based waveplates for precise control of polarized light.

The sintered film is mechanically robust and stable to an extent allowing it to be free-standing if not on a substrate. While prior art has considered sintering undesirable for such optical structure as sintering may change the shape of the nanorods to adversely affect the structure's optical properties, this patent specification describes techniques proving otherwise and achieving an unexpectedly good balance of mechanical strength and optical properties such as birefringence.

Liquid crystals can form nematic and cholesteric mesophases through self-organization of rod-like molecular entities in uniaxially oriented and helically stacked structures, respectively.^{13, 14} Transitioning from Angstrom to the nanometer scale, titanium dioxide (TiO₂) nanorods can be adopted as building blocks, giving rise to liquid-crystal-like superstructures and optical properties. The unique approach described below leverages established methods for functionalizing anatase TiO₂ nanorods¹⁵ and aligning nanorods¹⁶⁻¹⁸ to serve as a new strategy for the fabrication of inorganic, anisotropic films. In contrast to conventional textured ceramics generated by templated grain growth or applied external fields without exploiting spontaneous liquid crystalline formation,^{19, 20} the mesomorphic ceramics created as described below are prepared by simple, scalable, and low-cost processing. Also distinct from the use of liquid crystal fluids as templates to create solid superstructure of nanoparticles,²¹ the new approach described below employs an isotropic and volatile solvent to lower cost and simplify handling. In addition to optical devices for precise polarization control of incident light, manipulation of microstructure of inorganic ceramics can be critical to advancing diverse applications including photocatalysis,^{22, 23} dye-sensitized solar cells,^{24, 25} field-effect transistors²⁶ and piezoelectric ceramics.^{27, 28}

The new approach aims at transparent mesomorphic ceramic films processed to assume nematic and chiral-nematic superstructures as passive and active polarization devices for high-power laser applications. As a building block for passive polarization devices, nanoscale ceramic rods with the desired dimension, morphology, functionality, and chemical composition can be synthesized for the target mesomorphic ceramic films. Three approaches are envisioned to accomplish solid-state, mesomorphically ordered films. (1) Templating using commercially available nematic and chiral-nematic liquid crystalline fluids can be followed by removing the liquid crystal solvent by extraction with a volatile solvent subsequently evaporated off, and sintering the resulting particle assembly into the mesophormic ceramic film: (2) If ceramic rods self-organize into lyotropic liquid crystals in an isotropic solvent, the resulting orientational order can be be enhanced by solvent-vapor annealing before evaporating off the solvent without disturbing the resulting mesophase to produce a ceramic film; and (3) A colloidal suspension of aniosotropic particles can be field aligned (shear or e-field) and, simultaneously, aggregation of particles can be triggered by temperature or by solvent removal. For the fabrication of active polarization devices, laser dyes (e.g. rare earth ceramics) with light emission dipoles aligned with the ceramic hosts' chiral-nematic director can be employed for circularly polarized lasers.

According to some embodiments, a method of manufacturing mesomorphic ceramic films that are mechanically robust and stable and are free-standing absent a substrate comprises: providing a dispersion of suspension comprising inorganic nanorods on a substrate; blade-coating the dispersion or suspension into a film at speeds 2 cm/s or less between the blade and the dispersion or suspension on the substrate, applying a shear force to said dispersion or suspension to thereby flow-assemble the nanorods in preferred directions and to control the film thickness; and sintering the suspension into an optically anisotropic solid film that is mechanically robust and stable and is free-standing absent the substrate; wherein said sintered film is transparent to light and has a selected consistent birefringence over a wavelength range of visible and infrared light.

The method may further include one or more of the following features: (1) the step flow-assembling the nanorods and controlling film thickness can comprise causing relative motion between the substrate, with said dispersion of suspension thereon, and a doctor blade spaced a 10 μm or less from the substrate; (2) the providing step can comprise providing nanorods that comprise one or more of titanium dioxide, lanthanum phosphate, and zinc oxide; (3) the providing step can comprise providing nanorods that have anisotropic shapes that include at least one of rods and ellipsoids, with widths in the range of 10-50 nanometers and aspect ratios of 4 or more; (4) the providing step can comprise functionalizing said nanorods; (5) the method can further include calcination of said fluid film before said sintering; (6) the calcination can be at temperatures in the range of 300-550 degrees Centigrade; (7) the sintering can take place at temperatures in the range of 600-1,000 degrees Centigrade; (8) the nanorods in said fluid can be non-functionalized when in said dispersion or suspension film; (9) the method can further include controlling a temperature profile of said sintering to achieve a selected desired balance between mechanical strength and optical birefringence of said solid film; (10) the forming and sintering can cause said solid film to be 1 to 10 micrometers thick; (11) the forming and sintering can cause said solid film to have a surface area of a square centimeter or more; (12) the forming and sintering can cause said solid film to have a birefringence in the range of 0.015-0.40 over visible and near infrared light; (13) the forming and sintering can cause said solid film to have an optical transparency exceeding 90 percent; (14) including in said fluid an isotropic and volatile solvent; (15) forming said solid film can comprise forming a film that exhibits total birefringence that greatly exceeds the native birefringence of said nanorods; and (16) the nanorods in said fluid can be bare or attached with ligands.

According to some embodiments, a robust optical device polarizing light comprises: a sintered solid film of nanorods oriented in preferred directions; wherein said solid film is optically anisotropic and is sufficiently mechanically robust and stable to be free-standing; and wherein said sintered film is transparent to light and has a selected birefringence range over a selected wavelength range of the light.

The optical device can further include one or more of the following features: (1) the solid film thickness can be in the range of 1-10 micrometers; (2) the solid film can have an area of the order of a square cm or more; (3) the selected birefringence range can be 0.015-0.40 over visible and near infrared light; (4) the nanorods that have anisotropic shapes can include at least one of rods and ellipsoids, with widths in the range of 10-40 nanometers and aspect ratios of 4 or more; (5) the solid film can have an optical transparency exceeding 90 percent; (6) the nanorods comprise zinc oxide; and (7) the solid film exhibits total birefringence that greatly exceeds the native birefringence of said nanorods.

### BRIEF DESCRIPTION OF THE DRAWING

FIG. 1a schematically shows a blade coating operation and FIG. 1b is an example of aligned titania particles following blade coating at 1500 um s⁻¹. The film shows alignment of particles over the entire cross section of the film. The scale bar is 1 micrometer.

FIG. 2 shows an X-ray diffraction pattern of synthesized oleic-acid-capped TiO₂ nanorods to demonstrate the anatase phase after drying under vacuum at 50° C. overnight.

FIG. 3a shows a transmission electron microscopic image of oleic acid-capped TiO₂ nanorods in fabrication of mesomorphic ceramics with electron and optical microscopic images without substrate surface treatment; FIG. 3b shows a polarized optical microscopy image of lyotropic nematic mesophase at 60 wt % of oleic-acid-capped nanorods in chlorobenzene with white circles identifying Schlieren brush textures; FIG. 3c) shows assembled nanorods after calcination at 400° C. for 2 h(SEM); FIG. 3d shows the nanorods after sintering at 800° C. for 2 h (SEM); FIG. 3e is a cartoon depiction of lyotropic nematic assembly of oleic-acid-capped TiO₂ nanorods; FIG. 3f shows calcination thereof; and FIG. 3g shows sintering to create a nearly monodomain nematic-like film.

FIGS. 4a and 4b show TEM images at respective indicated magnifications of synthesized oleic-acid-capped TiO₂ nanorods. A drop of highly diluted dispersion was delivered onto a TEM grid with subsequent drying at room temperature before observation.

FIG. 5 shows thermogravimetric analysis of the oleic-acid-capped TiO₂ nanorods after 3, 6, and 8 centrifugation cycles. Samples were heated under vacuum at 50° C. overnight and in situ at 120° C. under N₂ for 1 h right before collecting the TGA scans at 20° C./min from 120 to 650° C. under air.

FIG. 6 shows POM images of 60 wt % oleic-acid-capped TiO₂ in chlorobenzene sandwiched between two glass substrates without surface treatment upon rotation of microscope stage for further confirmation of lyotropic nematic mesophase.

FIGS. 7a and 7b show narrowing of X-ray diffraction peaks as a result of sintering assemblies of titania nanorods without substrate surface treatment with normalized intensities versus 2θ for the crystallographic (004) and (200) planes; and FIG. 7c shows relative crystallite size after thermal treatment. The relative crystallite size was derived from the Debye-Scherrer equation for different crystal planes as described in the text. Errors in the plot correspond to the 95% confidence intervals of parameters used to fit diffraction peaks.

FIG. 8a shows 2D diffraction pattern from wide angle X-ray diffraction data acquired from a sintered mesomorphic ceramic flake sheared on a surface-treated substrate showing preferred orientation of crystal planes; FIG. 8b shows azimuthal scan for the (200) crystal plane of anatase, 3.28 nm⁻¹<q<3.36 nm⁻¹ (q=4π sin θ/λ); and FIG. 6c shows azimuthal scan for the (004) crystal of anatase, 2.61 nm⁻¹<q<2.69 nm⁻¹. Irregular (red in original) traces. FIGS. 8b and 8c indicate measured intensity, and smooth (black in original) curves are fitted Gaussians to determine the degree of orientational order.

FIG. 9a shows POM images taken with respect to the shearing direction oriented 45° illustrating optical properties of shear-aligned and sintered ceramic film between one surface-treated quartz substrate and the other untreated; FIG. 9b shows POM images taken with respect to the shearing directionoriented parallel to cross polarizers identical to those shown in FIG. 10 for a lyotropic nematic film before thermal treatments; FIG. 9c a photograph of a shield logo placed behind the sandwiched specimen demonstrating optical transparency; and FIG. 9d shows UV-Vis-NIR transmission spectrum and optical birefringence dispersion of 2.3-micrometer-thick films.

FIG. 10a shows POM image of uniaxially aligned oleic-acid-capped TiO₂ nanorods at 60 wt % in chlorobenzene sandwiched between one quartz substrate with surface treatment and the other without for a shear direction at 45°; and FIG. 10b shows POM image for a shear direction 0° relative to the cross polarizers. The arrow indicates the shearing direction, and the dashed lines indicate the cross polarizers.

FIG. 11a shows plotss of Mueller matrix elements versus wavelength from ellipsometric modeling of a mesomorphic ceramic prepared from lyotropic dispersion of anatase and sintered at 800° C.; and FIG. 11b shows wavelength dispersion of refractive indices acquired from ellipsometry. The data were first fitted at 0° angle of incidence for wavelengths from 600 nm to 1700 nm with an anisotropic Cauchy model to estimate the in-plane anisotropy. Oblique angle data sets in the transparent region were then applied to estimate the out-of-plane anisotropy as well as the relative tilt, which was found to be nearly 2° from the sample surface. The thickness and absolute refractive index were estimated by the coherent oscillations in m₁₂ at oblique incidence angles. To obtain the full characterization, the Cauchy model was converted to Kramers-Kronig consistent Sellmeier dispersion equations to expand into the absorbing region, where diattenuation in the m₁₂ element clearly indicates preferential absorption along only one of the two orthogonal in-plane orientations (which was modeled with the addition of a Gaussian oscillator). Similarly, data at 0° incidence was first applied for estimation before including more data at oblique incidence. Overall, the data fitting was reasonable as shown in FIG. 11b with small error in thickness and absolute refractive index due to the thickness non-uniformity that smears out most of the coherent oscillations. The anisotropic refractive indices from the ellipsometric modeling are presented in FIG. 11b for the evaluation of optical birefringence plotted in FIG. 9d.

FIG. 11ca illustrates transmission electron microscopy images of as-synthesized ZnO nanorods in aggregated form; and (11cb shows nanorods individually, using high-resolution imaging. The crystallographic c-axis runs perpendicular to the (002) planes and aligns with the long dimension of the nanorods.

FIGS. 12a, 12b, and 12c illustrate illustrates imaging and analysis of synthesized ZnO nanorods to determine their size and shape distribution using transmission electron microscopy image examples; and FIGS. 12d and 12e show length/diameter distributions of synthesized ZnO nanorods.

FIG. 13 shows polarized optical microscope image of ZnO nanorods suspended in ethanol at Φ_{ZnO}=20% captured under crossed polarizers. The white circles indicate nematic disclinations of the Schlieren texture.

FIG. 14 shows a Log-log plot of nanorod film thickness, hd, versus coating velocity, v for films blade-coated with α=90° and dgap=10 μm. Error bars correspond to ±one standard deviation of multiple measurements. With increasing coating velocity, thickness decreases in the evaporation regime (circles), reaches a minimum in the intermediate regime (triangles), and increases in Landau-Levich regime (stubs). Least squares fits to the data have a slope of −1.21±0.03 for the evaporation regime (upper dashed line) and 0.44±0.04 for the Landau-Levich regime (lower dashed line). The insets for all data points show two POM images of dried nanorod films, intended to exhibit uniform film orientation: in the left image of each pair, the coating direction is angled 45° to the polarizers, and in the right image the coating direction is parallel to a polarizer. The arrows inside the images indicate the flow direction, and the scale bar for all inset images is 400 μm.

FIG. 15 shows measured viscosity of stabilized ZnO nanorod suspension in the lyotropic mesophase η plotted as a function of shear rate. Linearity on log-log scales indicates a shear-thinning with power-law behavior. The best-fit line has a slope of −0.57±0.01.

FIG. 16 shows optical birefringence, and transmittance of blade-coated, dried films as a function of coating velocity. The minimum transmittance, T(%) in the spectral region from 633 nm to 1600 nm was measured at normal-incidence in transmission mode, and the inplane birefringence, Δn, was determined at the same wavelength by Mueller Matrix spectroscopic ellipsometry performed at multiple incidence angles based on a model with uniaxial, in-plane anisotropy.

FIG. 17 shows POM images of blade-coated dried nanorod films fabricated at 1 cm/s. Images were taken with the flow direction oriented 45° (left) and 0° (right) to a polarizer. Arrows indicate the direction of shear flow. The scale bar is 400 μm.

FIG. 18a shows scanning white-light interference microscopy images showing striped patterns on blade-coated dried nanorod films fabricated at velocities 1.65; FIG. 18b shows patterns for velocity 1.75; FIG. 18c FIG. 18b shows patterns for velocity 1.80; FIG. 18d shows patterns for velocity 1.90 cm/s; and FIG. 18e is a magnified view. The stripes are perpendicular to the coating direction.

FIG. 19a shows images and surface characterization of ZnO nanorod film fabricated by blade-coating at 2.00 cm/s and subsequent drying with a gap dimension of 10 μm in an image of transparent coating (5.0 cm×2.5 cm, dashed contour) on a microscope slide over logo; FIG. 19b shows POM image with the coating direction angled at 45° to the polarizers; FIG. 19c shows POM image with the coating direction parallel to a polarizer; FIG. 19d shows scanning white-light interference microscopy image showing root-mean-square and average surface roughness of the film surface; and FIG. 19e shows a top-view, SEM image showing the uniaxial alignment of TODA-functionalized ZnO nanorods along the blade-coating direction indicated by white arrow. The scale bar is 400 μm for all POM images and 200 nm for the SEM image.

FIG. 20 shows transmission spectrum of an optimal blade-coated film (lower graph) and calcined film (upper graph).

FIG. 21a shows Mueller matrix elements as a function of wavelength modeled by ellipsometry for optimal blade-coated film; and FIG. 21b shows the same paramers for a calcined film.

FIG. 22a shows refractive indices of optimal blade-coated film as a function of wavelength; and FIG. 22b shows the same indices for a calcined film as a function of wavelength.

FIG. 23 shows thermogravimetric analysis of dried blade-coated ZnO nanorods (bottom curve), calcined (to curve), and synthesized ZnO nanorods (middle curve). The blade-coated ZnO nanorods were dried under vacuum at 60° C. overnight. Samples were held at 120° C. under N2 for 1 h right before collecting the TGA data at 20° C. min−1 from 120 to 650° C. under air.

FIG. 24a shows images and surface characterization of the ZnO mesomorphic ceramic film after calcination in an image of transparent, crack-free film (5.0 cm×2.5 cm, dashed contour) on a microscope slide over logo; FIG. 24b shows POM image taken with the coating direction angled at 45° to the polarizers; FIG. 24c shows image taken with the coating direction parallel to a polarizer; and FIG. 24d shows scanning white-light interference microscopy image showing root-mean square and average surface roughness of the film surface after calcination; FIG. 24e is a top-view, SEM image showing the calcined, uniaxial superstructure of ZnO nanorods oriented with the blade-coating direction indicated by white arrow. The scale bar is 400 μm for all POM images and 200 nm for the SEM image.

FIG. 25a shows X-ray diffraction data of synthesized ZnO nanorods (green) and calcined ZnO in the mesomorphic ceramics (orange), specifically) X-ray diffraction intensity as a function of scattering angle. Diffraction peaks from (100), (002), (101) crystal planes of wurtzite structure are identified. FIG. 25b shows normalized intensities as 2θ for the (100) plane; and FIG. 25c shows normalized intensities as 2θ for the (002) planes.

FIG. 26a shows XRD Pole figures for the (002) plane; FIG. 26b shows XRD Pole figures for the (100) plane; and FIG. 26c shows XRD Pole figures for the (101) plane. The planes are of ZnO wurtzite structure acquired at 2θ value of 34.3°, 31.9°, 36.2° from mesomorphic ceramic thin film. The sample coordination is defined by the rolling direction (RD), transverse direction (TD), and normal direction (ND). The blade-coating direction (BCD) indicated by white arrows.

FIG. 27 is a plot showing contributions of form and intrinsic birefringence to the overall birefringence of a perfectly oriented composite as a function of ZnO volume fraction. The overall birefringence estimation utilized the anisotropic Bruggeman model in the homogeneous material containing monodisperse ZnO nanorods (aspect ratio of 20, ne=1.999, no=1.991 at 633 nm51) that are distributed in a medium (nvoid=1.000). The intrinsic birefringence's contribution was the native birefringence of ZnO (ne−no=0.008 at 633 nm) multiplied by Φ_{ZnO}. The cross mark indicates Φ_{ZnO} of the mesomorphic ceramic thin film on the overall birefringence curve experimentally determined by Mueller Matrix spectroscopic ellipsometry using the anisotropic Bruggeman analysis at multiple angles.

### DETAILED DESCRIPTION

Mesomorphic ceramics, with in-plane birefringence, can be fabricated from the lyotropic self-assembly of nanorods such as titania nanorods followed by thermal treatment, to form material that has unique properties compared to other titania ceramics, including both optical transparency and birefringence. The anisotropy in the resulting mesomorphic ceramic can be accomplished by macroscopic shear applied to a lyotropic suspensions of nanorods. This process can be scalable to cm-scale dimensions, overcoming the aperture limitation of known waveplates discussed above. Other single crystal nanorods could be used to make new materials following this technique.

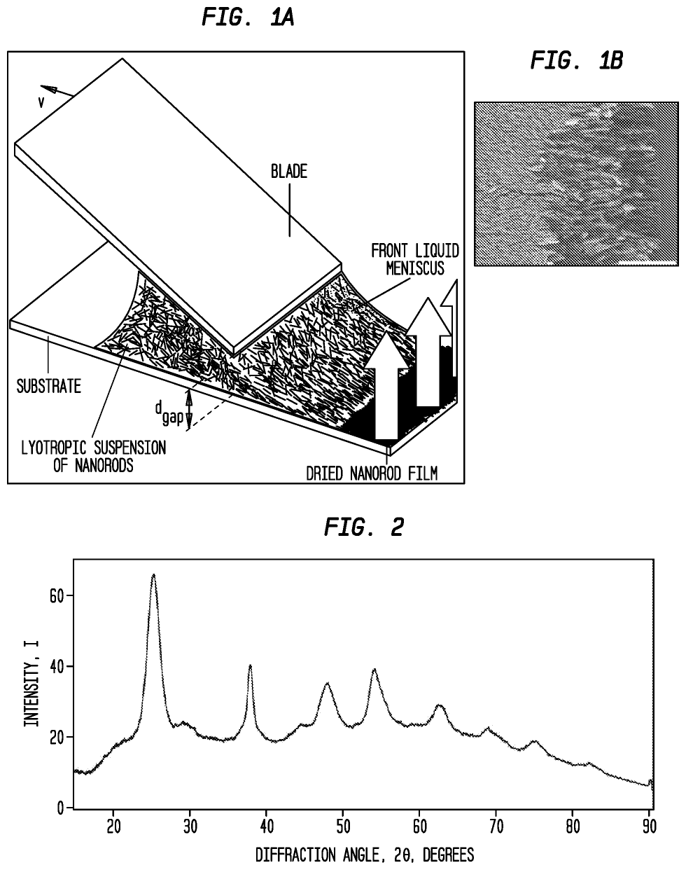

Blade coating is a popular thin-film fabrication method that involves dispensing a solution or suspension between a blade and a substrate as they are moved relative to one another while maintaining a constant gap dimension. During blade coating, the solution or suspension experiences shear forces as it passes through the gap and onto the substrate. As illustrated schematically in FIG. 1a, a suspension or dispersion of TiO₂ rods on a substrate is being spread by a blade spaced by a distance d from the substrate to form a film or coating that can be dried on the substrate. Carboxylate, phosphate and catechol can be considered as the ligand's surface anchoring groups. FIG. 1b is a micrograph showing at left an alignment of nanorods in film or coating due to blading. The scale bar is 1 micrometer. The substrate velocity and the blade angle alpha in FIG. 1a can be important parameters in the blade coating process. The substrate velocity should be high enough such that viscous stresses underneath the blade are high enough and viscous forces span across the thickness of the film. The blade angle and the liquid-to-blade wetting characteristics can help determine the shape of the meniscus under steady-state operation that also impacts the fluid stress field. The interplay between these factors can be be investigated using computational fluid dynamics. Blade coating preferably should be conducted at high concentrations of suspended nanoparticles (nanorods) to promote mesophase stability and orientational ordering. However, typically, if the concentration is too high, the suspension stability may be lost, and nanoparticles may aggregate in a disordered fashion. To promote colloidal stability, different surface ligands can be attached to the nanorods. Surface ligands that interact with solvent are desired because they can provide steric repulsion between nanorods, aiding in their colloidal stability. Simple aliphatic ligands as well as oligoethylene oxide ligands that potentially could be processed in ethanol or water can be considered. End-grafted, low molecular weight, low glass transition polymeric ligands such as poly(butyl acrylate)s that could enable viscous melts to be processed without solvents or with low amounts of solvent also can be considered. Ligand attachment onto the nanoparticles preferably should be strong enough to survive solvent and stresses experienced during processing. Carboxylate, phosphate and catechol as the ligand's surface anchoring groups can be considered.

Mesomorphic ceramics represent a new class of advanced materials characterized by novel low-cost synthesis using lyotropic liquid crystals of nanorods in an isotropic, volatile solvent in contrast to liquid crystal templated synthesis of nanomaterials. The mesomorphic ceramics as reported herein exhibit a preferred orientational order of the nanoscale grains' crystallographic c-axes within a nematic-like superstructure, thereby resulting in optical birefringence and transmission underlying robust waveplates for precise control of polarized light. The inorganic particle shape, surface functionality, and choice of suspending solvent all provide access to lyotropic phase stability, mesoscopic organization, and particle mobility, enabling facile orientation via external fields such as shear. Furthermore, avoiding a template offers a path forward toward dense and mechanically robust mesomorphic coatings. Above all, the bottom-up spontaneous assembly of nanoparticle precursors followed by sintering provides nanoscale control of both morphology and anisotropy not readily implementable in the synthesis of textured ceramics. Such control could have a significant impact on catalysis and photocatalysis, where crystal faces and edges greatly influence catalytic activity, and on solid-state electronics, including piezoelectrics and thermoelectrics. The more sophisticated helical stacking of nanoparticles can also be attempted to create chiral superstructures for circular polarization and optical isolation.

A detailed description of examples of preferred embodiments is provided herein. While several embodiments are described, the new subject matter described in this patent specification is not limited to any one embodiment or combination of embodiments described herein, but instead encompasses numerous alternatives, modifications, and equivalents. In addition, while numerous specific details are set forth in the following description to provide a thorough understanding, some embodiments can be practiced without some or all these details. Moreover, for the purpose of clarity, certain technical material that is known in the related art has not been described in detail to avoid unnecessarily obscuring the new subject matter described herein. It should be clear that individual features of one or several of the specific embodiments described herein can be used in combination with features of other described embodiments or with other features.

Experimental section. In an example of a proof-of-principle experiment, a synthesis of oleic-acid-capped TiO₂ nanorods was used. A reaction mixture was prepared with oleic acid (Alfa Aesar, 90%), titanium tetraisopropoxide (TTIP) (Sigma-Aldrich, 99.999%), and trimethylamino-N-oxide (TMAO) (Alfa Aesar, 98+%). The oleic-acid-capped TiO₂ nanorods (TiO₂-OLA) were synthesized following a published procedure.^{15,17} Oleic acid (140 g) was heated at 120° C. under vacuum for 1 hour to remove residual water and cooled to 90° C. followed by injecting TTIP (5.7 g, 20 mmol). After stirring for 10 min, 2 M aqueous solution (20 mL) of trimethylamino-N-oxide was quickly injected. The reaction mixture was then heated at 100° C. for 48 hours under Ar flow. After cooling to room temperature, the reaction mixture was dried under vacuum to remove water. About 400 mL of methanol was then added, the resultant precipitate was separated through three centrifugation cycles (14500 rpm, 15 min). The final product was dried and dispersed in chlorobenzene to form a 10 wt % transparent colloidal dispersion.

Formation of lyotropic nematic mesophase. Following the procedure reported by Cheng et al.,¹⁷ a dispersion of 10 wt % TiO₂-OLA in chlorobenzene slowly evaporated at room temperature while being observed under a polarized optical microscope. Evaporation continued until the desired concentration of 55-65 wt % was reached as determined gravimetrically. Gel formation was avoided by applying sonication and adding up to 10 wt % extra oleic acid. Once a highly birefringent mesophase was observed, the sample was sandwiched between a microscope glass slide and a cover slip for observation and processing. In addition, for the samples treated at 600° C. or higher, quartz substrates were employed instead of glass substrates and cover slips.

Fabrication and orientation of mesomorphic ceramics. A sandwiched cell containing a lyotropic assembly of nanorods was transferred into a box furnace (Lindberg, Blue M) for thermal treatment. The furnace was programmed to ramp at 1° C./min to a specified temperature for continued heating over 2 hours. Uniaxially aligned samples were fabricated by manually applying shear forces to lyotropic dispersions (at 60 wt % TiO₂-OLA in chlorobenzene) between one surface treated quartz substrate and one bare quartz substrate. Following the application of shear, thermal treatment was performed as described above.

Quartz substrate surface treatment. An adhesion promoter P20, consisting of 20% hexamethyldisilazane (Polysciences Inc.) and 80% propylene glycol monomethyl ether acetate (Transene Electronic Chemicals) and a positive photoresist (MICROPOSIT™ S1805™), were successively spin-coated (500 rpm, 5 s; 3000 rpm, 60 s; 500 rpm, 5 s) onto a pre-cleaned quartz substrate. After soft baking at 115° C. for 60 s, direct-write laser photolithography (Microtech, LW405) was performed to generate desired pattern (1 cm×1 cm) with the parallel lines (1 cm long, 5 micrometers wide) of 5 micrometers spacings under an exposing power of 135 mJ/cm². The substrates were then developed with developer (MICROPOSIT™ MF-319™) for 20-40 s and rinsed with water followed by blow drying with N₂. Hard baking was then performed at 115° C. for 120 s before reactive ion etching (South Bay Technology, Reactive Ion Etcher RIE-2000) under a gas mixture (O₂:15 SCCM, CHF₃: 10 SCCM and SF₆: 30 SCCM) for 2-4 min. The residual photoresist was rinsed off with acetone to obtain a trenched pattern substrate with a depth of 110-150 nm and a width of 5 micrometers verified by Profilometer (Ambios XP-200 Surface Profiler).

Characterization. The morphology, crystalline structure, and optical properties of the oleic-acid-capped TiO₂ nanorods, calcined and sintered products were extensively characterized. For thermogravimetric analysis (TA Instruments, Q5000), samples were dried under vacuum at 50° C. overnight and in situ at 120° C. under N₂ for 1 hour right before collecting the TGA scans at 20° C./min from 120 to 650° C. under air. Transmission electron microscopy (FEI Tecnai F20 G2) was employed to characterize oleic-acid-capped TiO₂ nanorods, and scanning electron microscopy (Zeiss, Auriga) for surface morphology after calcination and sintering. Polarizing optical microscopy (Leica, DM LM/P) was performed to observe birefringent texture of samples. X-ray diffraction was performed using XtaLAB Synergy-S diffractometer (Rigaku) with a 2D HyPix-6000HE HPC detector, and data were analyzed using CrysAlis^{Pro} (Rigaku) and Data Squeeze (University of Pennsylvania). To determine the crystalline structure, XRD was performed using Cu Kα X-rays with a sample-to-detector distance of 31.2 mm and an exposure time of 10 min. To analyze the preferred orientation of crystallites, single flakes with lateral dimensions of 100-200 micrometers were mounted with the shearing direction oriented normal to the incident beam, and XRD was performed to higher q-range using Mo Kα X-rays at a distance of 36.5 mm and an exposure time of 5 min. Brunauer-Emmett-Teller (BET) (micromeritics, ASAP 2020) analysis was conducted to measure the specific surface area of the calcined and sintered sample. The bulk sample for BET analysis was dried in vacuum oven overnight before ramping at 20° C./min to the target temperature and hold there for 2 hours. A UV-vis-NIR spectrometer (Perkin-Elmer, Lambda 900) was employed to measure the transmission spectrum of the sintered sample between a pair of quartz substrates relative to a reference cell consisting of the same substrates with an air gap. Spectroscopic Mueller-matrix Ellipsometry (J. A. Woollam, RC2) measurements were collected at variable angles in transmission to obtain the film thickness and optical birefringence of the sintered sample.

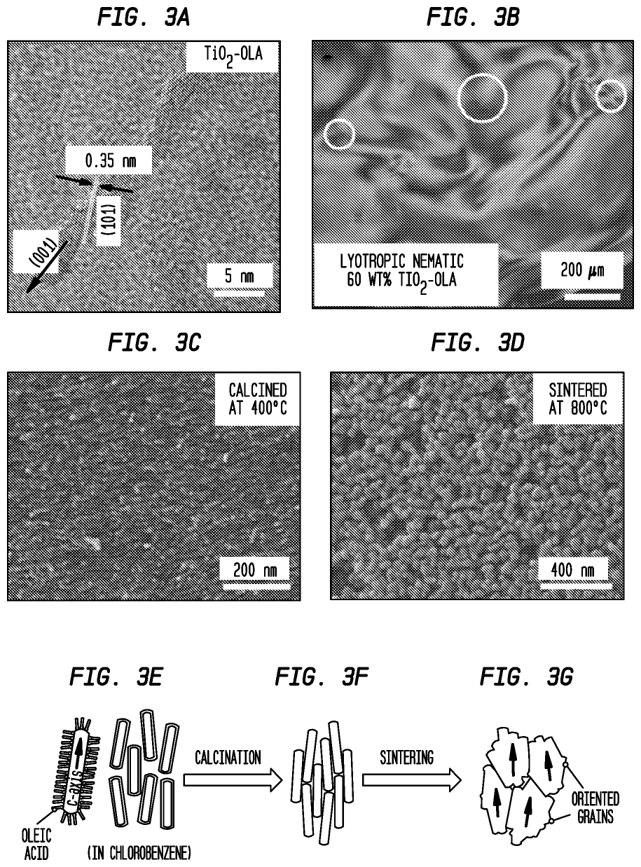

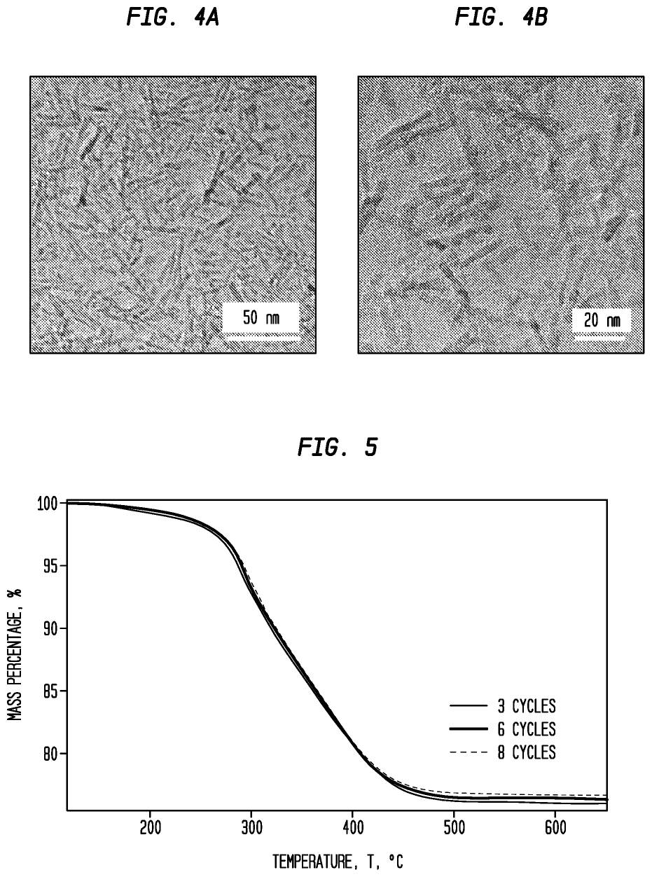

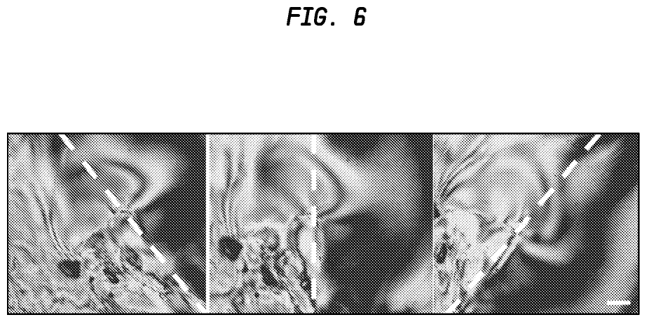

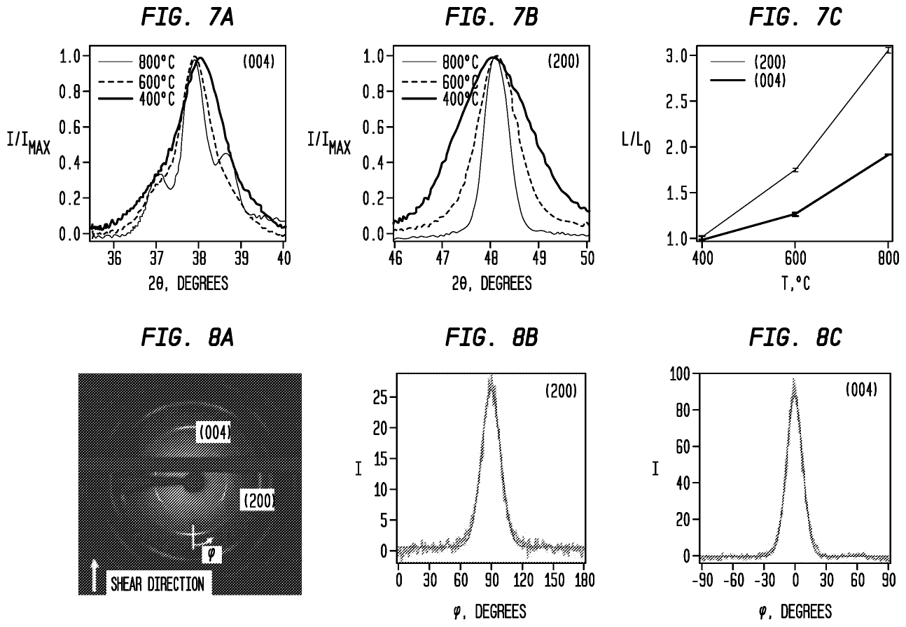

Results and Discussion. As building blocks for mesomorphic ceramics, oleic-acid-capped TiO₂ nanorods were synthesized in one pot through hydrolysis of titanium tetraisopropoxide in oleic acid under mild conditions.¹⁵ Nanorods were characterized as anatase phase by X-ray diffraction (XRD, FIG. 2), and the shape and dimension of the single crystallite nanorods were characterized by transmission electron microscopy (TEM) as shown in FIGS. 3a and 4.¹⁵ The nanorods' length and aspect ratio are estimated at 20 to 30 nm and 5 to 8, respectively, similar to those previously reported.¹⁷ Moreover, the c-axis of titania's anatase phase is oriented along the nanorods' long axis as shown by the high resolution TEM image in FIG. 3a, where the (101) plane is labeled to identify the anatase phase.^{15, 29} According to the TGA thermograms compiled in FIG. 5, the ligand-capped nanorods contain 24 wt % oleic acid. The as-synthesized oleic-acid-capped anatase nanorods were readily dispersed in chlorobenzene to yield temporally stable lyotropic nematic liquid crystals as described above.¹⁷ The image in FIG. 3b shows a birefringent texture observed at room temperature between glass substrates of nanorods dispersed at 60 wt % in chlorobenzene. The Schlieren texture is consistent with a lyotropic nematic mesophase, which is further supported by its response to shear and the rotation of brush disclinations both with and counter to stage rotation; see FIG. 6.³⁰ The sandwiched samples containing lyotropic dispersions were subjected to thermal treatments. The material after calcination at 400° C. for 2 hours appears as a solid film under SEM, showing a dense assembly of nanorods in FIG. 3b that suggests preferentially oriented crystalline grains with dimensions comparable to those of pristine nanorods. To solidify the anisotropic microstructure from the lyotropic phase into a continuous film, thermal treatments at both 600 and 800° C. were performed for 2 hours each. Based on TGA data, the resulting mesomorphic ceramics contain no residual solvent nor oleic acid. FIG. 3d shows the SEM image of crystalline grains ranging from 25 to 75 nm following thermal treatment at 800° C. The enlarged grains appear as ellipsoids with reduced aspect ratios, and angular facets are visible on some grains suggesting crystallinity. The process begins with lyotropic ordering of single crystallite nanorods, captured in FIGS. 3e and 3f, which are fused together to form crystalline grains as depicted in FIG. 3g. The final product, an ensemble of grains with preferentially aligned crystallographic axes, is termed a mesomorphic ceramic domain and will be elaborated upon further below.

The sintering behavior was further characterized by both XRD analysis and specific surface area measurement. Bragg diffraction peaks for the (004) and (200) planes narrow upon thermal treatment, as shown in FIG. 7, suggesting that the anatase crystallites grow upon treatment at increasing temperatures (e.g. 400° C., 600° C., and 800° C.), consistent with the grain coarsening shown in FIG. 3d. Sintering was also evident from the specific surface area quantified by the Brunauer-Emmett-Teller (BET) technique, which indicates significantly reduced values from 305 m²/g to 74 m²/g following the treatment at 400 and 600° C., respectively. The optical quality of specimens sintered at 600° C. was observed to be inferior to that following sintering at 800° C. In addition, XRD analysis was conducted to probe the reduction in shape anisotropy upon sintering at high temperatures as a corroboration for the SEM images in FIGS. 3c and 3d. The change in length scale of a crystallite dimension normal to a selected diffraction plane can be calculated from the Debye-Scherrer equation as L=Kλ/μ cos θ where K is a shape constant, λ is the wavelength of the X-ray beam, θ is the Bragg angle, and β is the full width at half-maximum, FWHM, of the selected diffraction peak. FIG. 7c shows the relative changes of sizes, L/L0, where L0 is the crystallite dimension after thermal treatment at 400° C., for both the (200) and (004) planes. As a result of sintering, the average dimension normal to the crystallite's (200) plane nearly triples, and the average dimension normal to the (004) plane nearly doubles. Since the c-axis lies along the long axis of the nanorods, these observations indicate that nanorods tend to fuse together primarily in the lateral direction during sintering, as expected of their shape-induced nematic order. This explains the loss in shape anisotropy of crystalline grains after sintering at 800° C. as also observed in the SEM image in FIG. 3d.

To further investigate the orientation and optical properties of mesomorphic ceramics prepared from liquid crystalline dispersions, and to evaluate their potential to serve as waveplates, lyotropically assembled nanorods were processed into a nematic monodomain by manual shear on a surface-treated substrate followed by sintering. The preferred orientation of the shear-aligned, mesomorphic ceramic film sintered at 800° C. was characterized using wide angle X-ray diffraction. FIG. 3a shows the 2D-XRD pattern of a flake that was oriented orthogonal to the beam, with the shear direction vertically aligned. The 2D-XRD pattern is consistent with uniaxial orientation along the c-axes of the grains formed from fused nanorods and shows orientational order of crystallographic planes parallel (200) and perpendicular (004) to the grain's c-axis. FIGS. 3b and 3c display the azimuthal variation in intensity for the (200) and (004) planes. Part of the detector was unavoidably blocked by the beamstop. To circumvent this effect in the analysis of the full azimuthal intensity profile, the sample was rotated azimuthally in 45° increments, and the collected data were averaged. The preferred orientation is characterized by the degree of orientational order defined as f=[180°−FWHM]/180°, where FWHM in degrees is calculated from a least-squares fit to the Gaussian function.³¹ The calculated f values at 0.88 and 0.90 for the (200) and (004) planes, respectively, signify good alignment of the anatase crystallites' c-axes along the shear direction.

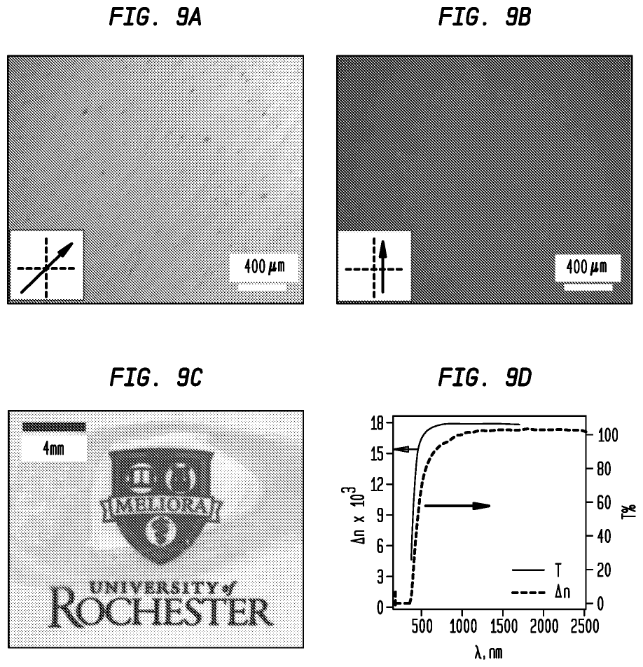

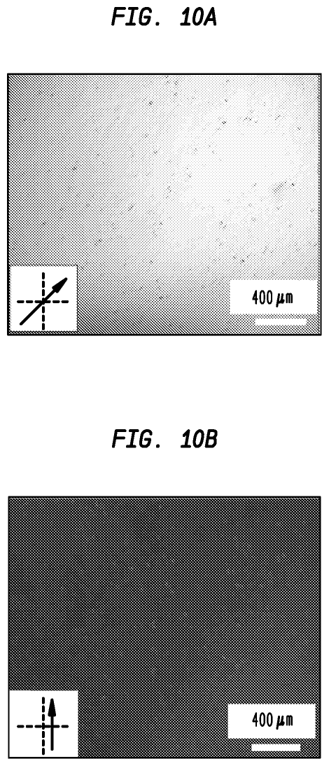

The optical properties of macroscopically aligned mesomorphic ceramic film were further investigated as shown in FIG. 9. When viewed under cross polarizers, the sheared and sintered specimen appears birefringent over millimeter length scales. FIGS. 9a and 9b show light transmission through cross polarizers if the sample is sheared at 45° to a polarizer, while extinction is observed if sheared along either polarizer. These observations indicate that the specimen displays in-plane birefringence over millimeters that originates from the lyotropic nematic assembly, consistent with the optical property expected of FIG. 3g for a nearly monodomain nematic film composed of crystalline grains with preferred orientation. It appears that the preferred orientation of nanorods imparted by shearing was preserved upon sintering, forming a nematic-like superstructure with permanent, in-plane birefringence. The mesomorphic ceramic film sandwiched between two quartz substrates exhibits excellent transparency over the millimeter length scale as shown in FIG. 9c. The UV-vis-NIR transmission spectrum in FIG. 9d shows optical transparency from 600 to 2500 nm. Note that the transmission appears to exceed 100% presumably because Fresnel reflection from the mismatch of refractive indices between the ceramic film and the quartz substrates is not fully accounted for by the empty reference cell. The high transparency is attributed to the small crystalline grains size and small pore size that limits losses due to scattering.³²

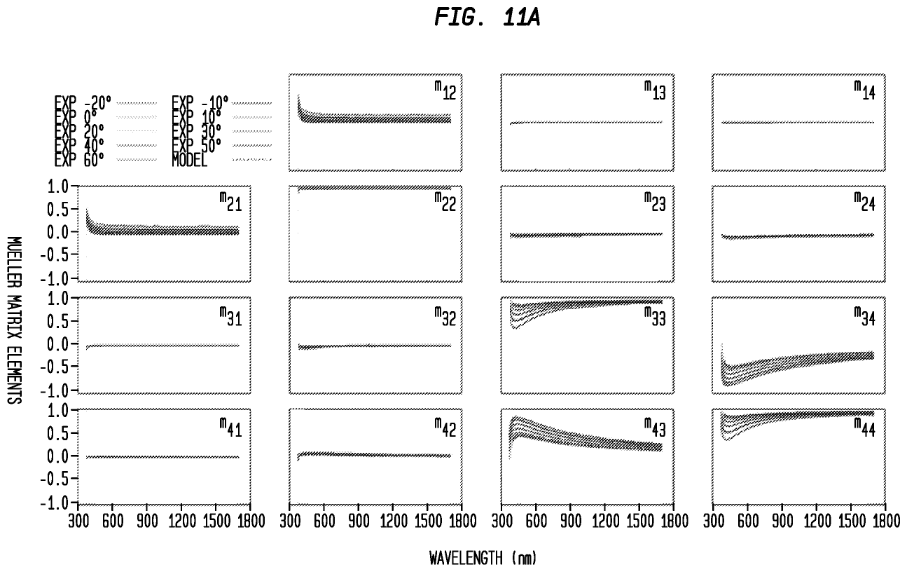

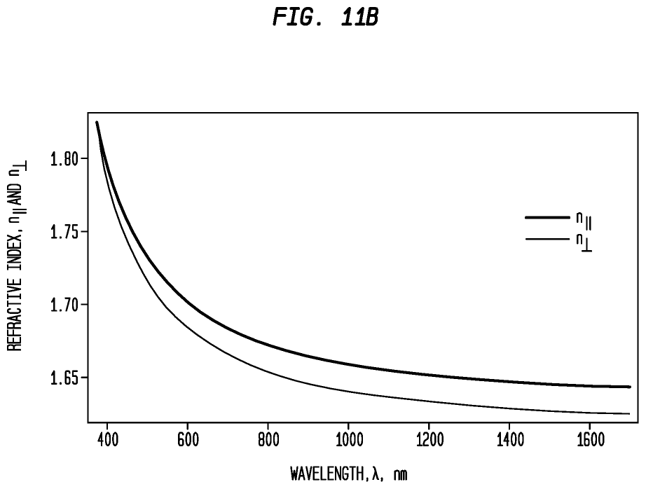

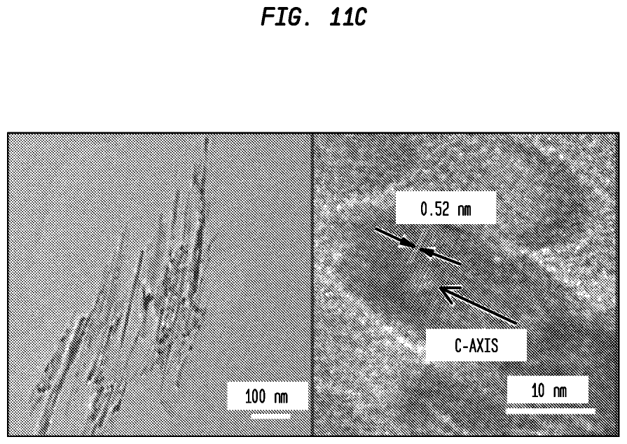

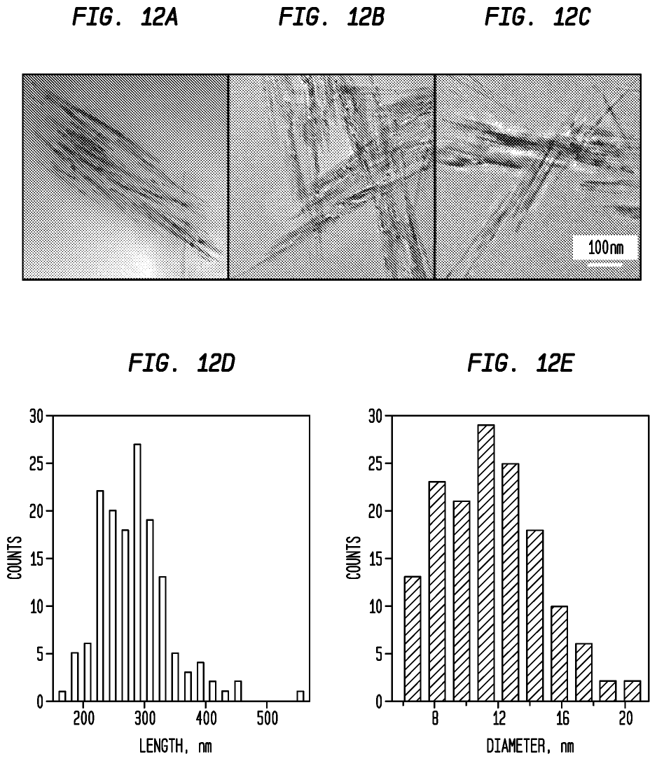

The film thickness and birefringence of the same mesomorphic ceramic film were independently determined by measuring the Mueller Matrix in transmission mode (MMt) at varying incidence angles followed by analysis with biaxially anisotropic model.³³ Each orientation was described using a Kramers-Kronig consistent Sellmeier dispersion relation,³⁴ with one orientation including a Gaussian absorption to describe the onset of absorption before the film became opaque at shorter wavelengths. The thickness was determined to be 2.3±0.3 micrometers by matching the coherent oscillations at an oblique incident angle. Much of this uncertainty is due to the non-uniformity of the film across the measured beam, which was considered in the model. The wavelength dispersion of optical birefringence is shown in FIG. 9d, which indicates a nearly constant optical birefringence, Δn=n_{∥}−n_{┘}=0.018±0.002 at wavelengths exceeding 650 nm corresponding to a retardance of about 40 nm. Here n_{∥} and n_{┘} are refractive indices parallel and perpendicular, respectively, to the orientation induced by shearing and surface treatment. To enable device design for a targeted application, the retardance value can be optimized by adjusting film thickness and optical birefringence. The sharp change in birefringence at λ≤600 nm is caused by anisotropic light absorption prescribed by the Kramers-Kronig relation, namely, the refractive index along the absorption direction increasing faster towards shorter wavelength than the orthogonal. The full MMt data and the model are provided in FIG. 11.

The preferred crystallographic orientation evidenced by FIG. 8 can be combined with morphological and optical characterization data to offer a physical picture of the sintered material depicted in FIG. 3g. Nanorod precursors sinter into distinguishable, low aspect ratio crystalline grains identifiable from SEM in FIG. 3d. Sintering results in preferred lateral growth of crystalline grains as shown by the X-ray diffraction data in FIG. 7. Together, the X-ray diffraction data, the observed shear-induced orientation, and the measured optical birefringence (FIG. 9) confirm that the domains exhibit preferred uniaxially order of their crystallographic c-axes, or equivalently their nematic directors. In a nutshell, the collection of grains shown in FIG. 3g can be interpreted as a nematic superstructure, culminating in one of the targeted mesomorphic ceramics.

Prior to the novel methodology based on lyotropic liquid crystals, LLC, physical vapor deposition has been practiced particularly for sculptured TiO₂ films by GLAD^{[10]} and SBD, serial bideposition,³⁵ with varying degrees of sophistication. Compared with GLAD and SBD, the LLC approach is cost-effective for processing while enjoying process scalability and superior optical transparency at least from 500 to 2500 nm through micron-thick films, as FIG. 9d herein is contrasted with FIG. 8 of Ref. 35, presumably because of the smaller pores through the LLD film compared with the SBD film. On the other hand, the SBD film's optical birefringence has been reported to be an order-of-magnitude greater than the LLC film at 550 nm.^{35, 36} The higher optical birefringence value of the SBD film than that of the LLC film is accountable by the former consisting of form birefringence while the latter mostly of the intrinsic birefringence.

As noted above in the Background section of this patent specification, large aperture, ceramic-based waveplates that can withstand high laser fluences are demanded for satellite imaging, biological imaging, beam isolation, and power attenuation. Such waveplates are challenging to fabricate because they require precise optical retardance over large areas. Waveplates made from quartz or calcite are appealing due to their high laser-induced damage thresholds, but they are costly because they must be precisely machined from large, single crystals.¹ In contrast, mesomorphic ceramics are anisotropic polycrystalline solids with morphologies intermediate between isotropic materials and single crystals such as sculptured inorganic thin films fabricated via glancing angle deposition (GLAD). However, GLAD is limited by defect control and thus is limited to small areas.²⁻⁵ Soft materials like polymers and liquid crystals can be inexpensively processed into large area waveplates; however, they lack the thermal stability and photostability desired for high power laser applications. Thus, there is a standing need for cost-effective, inorganic waveplates with quality surface finish over large areas.

Directed assembly of nanoparticles from colloidal suspensions has been demonstrated in pursuit of applications in optics,⁶ thin film electronics,^{7, 8} optoelectronics,⁹ and catalysis.¹⁰ Macroscopic alignment of nanoparticles over large areas typically requires the use of external fields or interfaces followed by solvent removal. For example, electric or magnetic fields can direct nanoparticle self-assembly across liquid films, resulting in vertically aligned nanorods. However, generating crack-free, anisotropic solid films with in-plane alignment remains challenging.¹¹⁻¹⁷ Interfacial assembly methods such as Langmuir-Blodgett techniques rely on surface active particles and can produce ordered monolayers of nanorods over large areas, but alignment is not readily controlled beyond a monolayer.¹⁸

Shear alignment of nanoparticle suspensions is effective between flat substrates.¹⁹⁻²¹ Applicant has recently reported a new approach to preparing mesomorphic ceramics films from lyotropic nematic suspensions of functionalized TiO2 nanorods.¹⁹ The lyotropic mesophase was manually sheared in a sandwich cell to achieve a monodomain of oriented rods that were subsequently calcined and partially sintered to produce a 2.3 μm-thick, solid film over millimeter dimensions exhibiting optical transparency at 650 to 1700 nm, with a modest birefringence of 0.018.

Flow-directed particle assembly methods including spin-coating,²² dip-coating,²³⁻²⁵ and blade-coating^{26, 27} combine shear flow with solvent removal and can be readily scaled to large areas. However, obtaining a good optical quality surface finish remains a challenge because of defects during solvent evaporation.^{23, 24, 26} During blade coating, a thin film of nanorods is spread across a substrate by the motion of a blade while maintaining a uniform distance from a stationary substrate. The nanoparticle orientation and defect formation within the film depend on the nanorod volume fraction, coating velocity, and blade angle, while the film thickness scales with coating velocity.²⁶ It is desirable to optimize the blade coating process for fabrication of crack-free, uniform, and birefringent nanorod films that can serve as green bodies for mesomorphic ceramics.

This patent specification describes a directed assembly of nanorods into optically birefringent, mesomorphic ceramic films that are uniform over large areas. The method involves: (i) blade-coating of lyotropic nanorod suspensions to achieve stable, oriented monodomains, and (ii) calcination to remove organic ligands. It is a scalable approach to optically anisotropic, inorganic solids, broadly applicable to other inorganic nanorods, including mineral liquid crystals,²⁸⁻³⁰ as precursors to mesomorphic ceramics. Analysis of film morphology and optical properties to be conducted as follows provides a basis to optimize subsequent materials processing steps, including sintering and additional steps to obtain robust, solid-state optical devices.

Described below are films and optical devices using ZnO nonorods and optimization thereof.

Synthesis of ZnO nanorods. Zinc Oxide nanorods were prepared following Sun et al.⁷ Zinc acetate dihydrate (6.59 g, Honeywell, 99.0+%) and potassium hydroxide (2.70 g, Fisher Chemical, 86.4%) were dissolved separately in 60 mL of methanol (99.8+%). The potassium hydroxide solution was added dropwise to the zinc acetate solution while vigorously stirring under reflux conditions (60° C.). The mixture was further refluxed for 2 h, and the solution changed turbid, indicating the formation of ZnO agglomerates. The suspension was concentrated by a factor of 10 and refluxed for five days further to grow high aspect ratio ZnO nanorods. For purification, the product was centrifuged at 7000 rpm for 30 min, washed with methanol, and redispersed by ultrasonication. This purification procedure was repeated three times.

Surface functionalization of ZnO nanorods. Following Voigt et al.,³¹ 30 wt. % of [2-(2-methoxy ethoxy)ethoxy] acetic acid (TODA, Sigma-Aldrich) was added to the ethanol suspension of synthesized ZnO nanorods. Following ultrasonication for 1 h at 25° C., a stable suspension of TODA-functionalized ZnO nanorods (Φ_{ZnO}˜17.0%) was obtained. Solvent was slowly removed until the lyotropic nematic phase was observed by polarized microscopy of a single droplet of the nanorod suspension. The mass of solvent removed to reach the lyotropic phase was determined gravimetrically.

Blade Coating and calcination. A schematic of the blade coating process for flow-directed particle assembly is shown in FIG. 1. The gap distance and blade angles were first adjusted using stage micrometers to maintain a constant gap during the coating process. A reservoir (100 μL droplet) containing a colloidal, lyotropic suspension ZnO nanorods was placed on a flat substrate, between the substrate and a tilted blade, assisted by capillary forces. After placing the droplet, the blade was immediately driven by a computer-controlled motor (VEXTA stepping motor, PK264-01B) to spread the suspension a constant velocity across the substrate, forming a film while maintaining a constant gap distance. Solvent evaporated during or shortly after coating to form a thin film of nanorods on the substrate. Before characterization, all deposited films were further dried under vacuum at 60° C. for 12 hours. A thoroughly dried, blade-coated film was heated in a convection oven (BINDER, FD056UL) at a ramp rate of 1° C. min−1 to 280° C. for 30 min to remove the organic ligand, leading to mesomorphic ceramics.

Characterization. Bright-field transmission electron microscopy (FEI, Tecnai F20 G2) captured images of ZnO nanorods. Each rods' length, diameter, and aspect ratio were determined by measurement of 150 individual nanorods using image analysis software (ImageJ). Powder X-ray diffraction of synthesized rods was conducted using a diffractometer (Rigaku, XtaLAB Synergy-S) with a 2D detector (Rigaku, HyPix-6000HE). The rheology of stabilized ZnO nanorod suspensions was evaluated at 25° C. using a rheometer (TA Instruments, Discovery HR-2) equipped with a 20 mm diameter cone-and-plate fixture. The organic fraction of TODA-functionalized nanorods as well as calcined films was determined using thermogravimetric analysis (TA Instruments, Q5000). Prior to each thermogravimetric scan, samples were held at 120° C. under N2 for 1 h and then ramped at 20° C. min−1 from 120 to 650° C. under air purge.

The thickness, roughness, optical properties and texture of blade-coated films extensively characterized before and after calcination. Spectroscopic Mueller-matrix ellipsometry (J. A. Woollam, RC2) was performed in transmission mode to determine the in-plane birefringence and film thickness via MMt analysis at multiple angles in the uniaxially anisotropic model, while the optical transparency was measured at zero-incidence-angle. Scanning white-light interference microscopy (Zygo, NewView 600TMS) was performed to measure surface roughness and further verify the measured thickness. Scanning electron microscopy (Zeiss, Auriga) under the InLens mode was utilized to evaluate surface morphology before and after calcination. All SEM samples were dry etched to remove organics using oxygen plasma (South Bay Technology, PC-2000). Texture analysis was performed following calcination of blade-coated films by X-ray scattering (Philips, X'Pert PRO MRD).

A report regarding Results and discussion follows.

Nanorod Synthesis. High aspect ratio zinc oxide nanorods promote lyotropic ordering and are therefore the primary subject of this portion of the patent specification. Furthermore, ZnO inherently offers appealing laser damage resistance and anisotropic optical properties.³² Zinc oxide nanorods comprise of wurtzite crystals with their crystallographic c-axis oriented along the rods' long dimension, supporting in-plane birefringence of a monodomain film.

Zinc oxide nanorods were prepared following Sun et al. by reaction of zinc acetate dihydrate with potassium hydroxide.⁷ The lengths and diameters of resulting nanorods are estimated by TEM, at 294±59 nm and 12±3 nm, respectively, as shown in FIG. 11a. Results from individual measurements of 150 nanorods are shown in FIG. S2, indicating the average aspect ratio exceeding 20. Both X-ray diffraction (see FIG. S1) and high-resolution TEM (see FIG. 11b) confirm that the resulting ZnO nanorods are wurtzite with their crystallographic c-axis oriented along the nanorod's long axis. The (002) plane is labeled in FIG. 11 with its d-spacing measured to be 0.52 nm, in agreement with wurzite.³¹

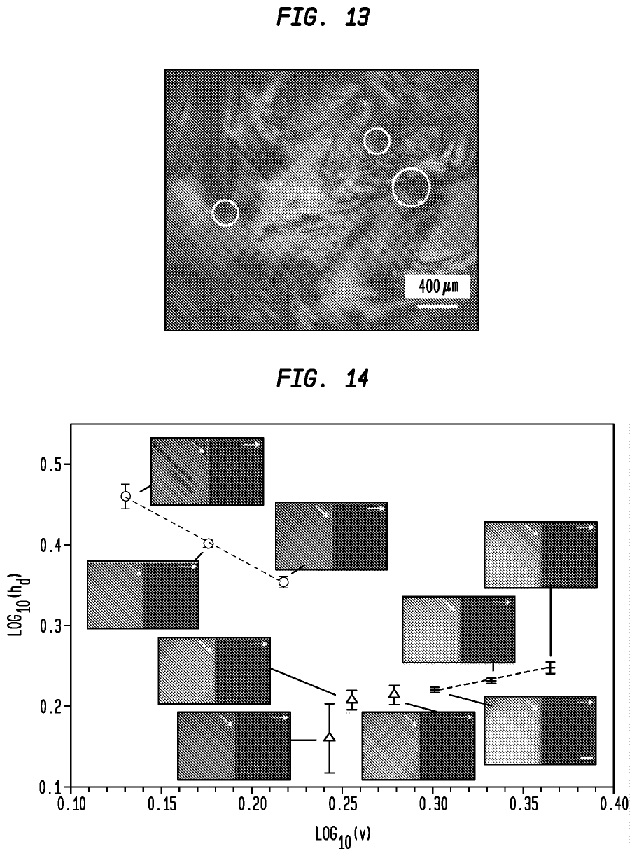

To preclude aggregation of nanorods in ethanol, [2-(2-methoxy ethoxy) ethoxy] acetic acid (TODA) was introduced as a stabilizer.³³ TODA offers sufficient short-range repulsion to achieve colloidal stability in ethanol at volume fractions where lyotropic nematic mesomorphism emerges. FIG. 13 shows the liquid crystalline texture of stabilized ZnO nanorods in ethanol at a volume fraction of 20%. The Schlieren texture includes extinction brushes around line disclinations, consistent with the lyotropic nematic mesomorphism observed in other inorganic oxide rod systems.^{20, 21} Such disclinations are points in space where the nanorod director is not well defined, and dark brushes correspond to regions where the nanorods are oriented parallel to one of the polarizers. These reflect that the local director of nanorods forms patterns around defects.³⁴ To further demonstrate the formation of a lyotropic nematic mesophase, the nanorod suspension was mechanically sheared in a sandwich cell, and the resulting response was observed between crossed polarizers. Upon shear, the formation of a monodomain was evidenced by the appearance of uniform, birefringence under POM.

Flow-Directed Assembly of Nanorods. Lyotropic suspensions of ZnO nanorods were shear-oriented using a customized blade-coating apparatus shown in FIG. 1. A lyotropic suspension of nanorods is loaded between a tilted blade that is separated from a substrate by a uniform gap. The blade is driven at a constant velocity to spread the suspension on a stationary plate over a large area. The focus is to identify conditions where shear flow most effectively aligns the lyotropic suspension into a monodomain film to be preserved in the solid state by subsequent solvent evaporation and calcination.

The thicknesses of the dried nanorod films coated at a blade angle α=90° and a gap dgap=10 μm are plotted against coating velocity on a log-log scale in FIG. 14. Dried film thicknesses range from 1.26 μm to 2.94 μm and are grouped according to previously studied scaling regimes for dip-coating and blade-coating processes.^{23, 24} Each coating regime is briefly discussed as follows. At low coating velocities (v≤1.65 cm/s) the thickness of the dried film, hd, decreases with increasing coating velocity, v. For these data, FIG. 14 shows a log-log linear fit to the power law scaling relationship:

h_{d}∝v^{a}, [1]

and the least-squares fit corresponds to a scaling exponent of a=−1.21±0.03. This exponent is consistent with the evaporation regime, whereby solvent removal occurs mainly in the front liquid meniscus, and the viscous forces acting against capillary forces are negligible.³⁵ Within this regime, if the total evaporative flux is independent of coating velocity, a simple mass balance suggests a scaling exponent of a=−1.³⁶. In another limiting case within the evaporation regime, evaporation is reduced by pore-emptying of a wet, densely packed colloid film, and the exponent is predicted to be −2.³⁷ Our observed scaling exponent lies between these two limits, indicating that, while most evaporation occurs around the meniscus, the evaporation rate also decreases once the densely packed colloid structure begins to form.

At high coating velocities (v≥2.00 cm/s), blade-coated films were found to thicken at an increasing velocity, indicative of the Landau-Levich regime.^{24, 26, 36} There, evaporation at the meniscus is negligible, and viscous forces exceed capillary forces, dragging more material onto the substrate. Those data points were fit using the same power law relationship (Eqn. 1) to obtain a scaling exponent of a=0.44±0.04.

To analyze the results in the Landau-Levich regime, note that the underlying physics is connected to the fluid's rheological behavior.³⁸ Noting that the viscosity of a power-law fluid, depends on the local shear rate, \dot{γ}, with n∝\dot{γ}ⁿ⁻¹ where n is fluid's rheological index, Lau et al.³⁸ integrated a simple power-law fluid into the Landau-Levich framework to express the coating's dry film thickness as a function of velocity and the power-law fluid's rheological index:

h_{d}∝v^{2n/(1+2n)}. [2]

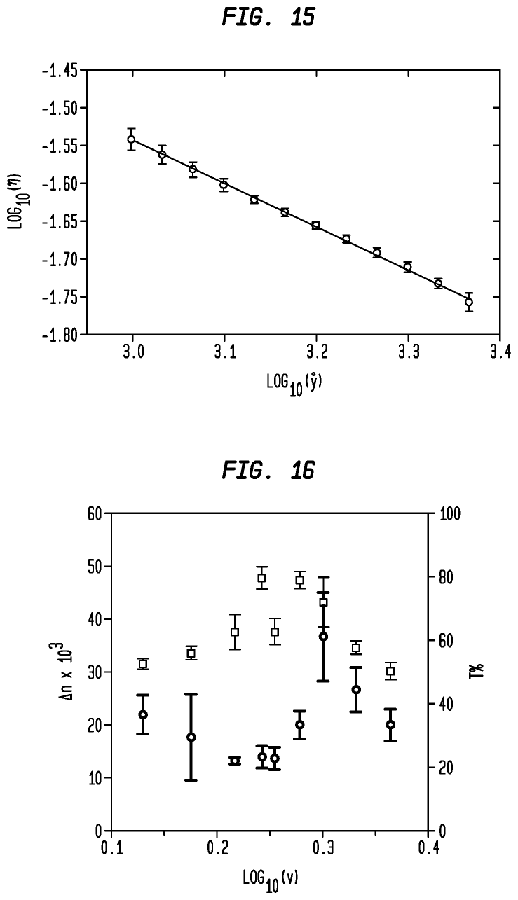

Steady-shear rheology on the lyotropic ZnO nanorod suspension (Φ_{ZnO}=20%) showed it to be shear-thinning with a rheological index of n=0.43 (see FIG. 15). Substitution of this index into equation 2 results in a scaling exponent of a=0.46 which is in experimental agreement with the least-squares shown in FIG. 14 of a=0.44±0.04. The agreement indicates a relationship between the dry film thickness and only two input parameters: the coating speed and suspension's rheological index. This relationship can be useful in perfecting the blade-coating process.

At intermediate coating velocities (1.75 cm/s≤v≤1.90 cm/s) the thickness trend reverses due to the competition between evaporation and frictional drag. In this regime, measured thicknesses are lower than extrapolated lines from the surrounding evaporative and Landau-Levich regimes. This is an unexpected result, and the deviation from the other scaling regimes is attributed to the emergence of striped pattern discussed in the next section.

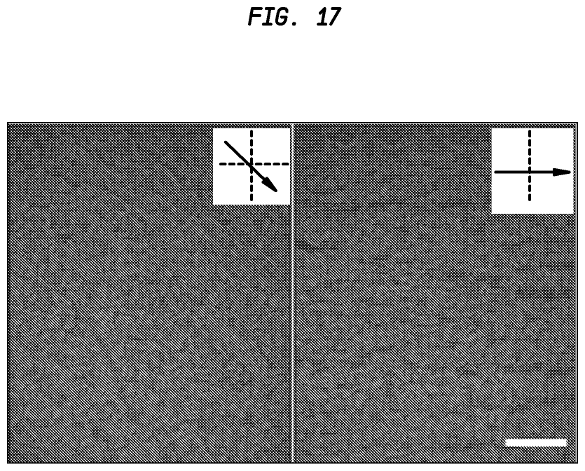

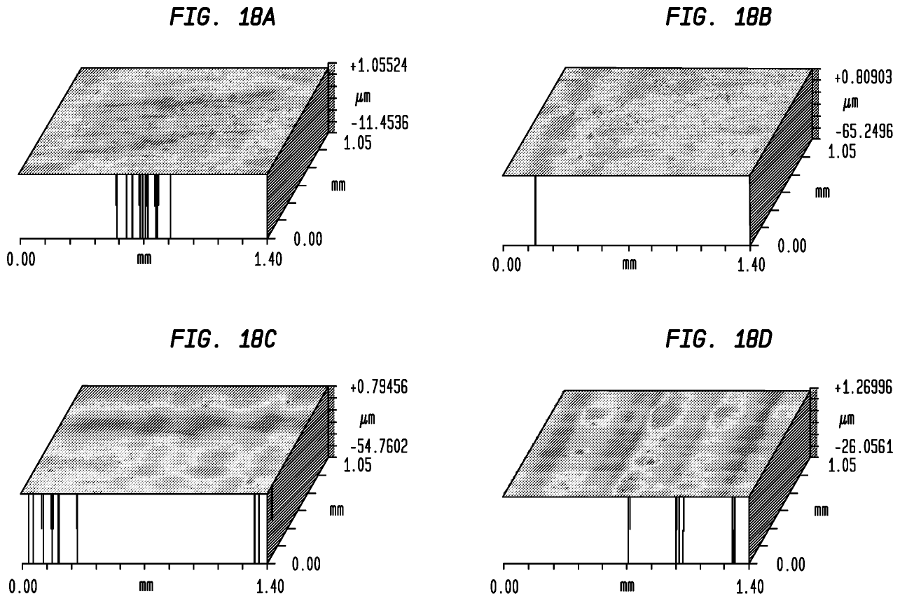

Optical Defects in Blade-Coated Films. To identify good processing conditions to accomplish large area, optical quality films, blade-coating was performed at coating velocities ranging from 1.00 to 2.32 cm/s, with gap spacings of 10, 20, 40 and 45 μm. Optical defects within each film were qualitatively assessed by POM observation, and the transmission and birefringence were measured by ellipsometry. Coatings using a gap spacing greater than 10 μm consistently lacked transparency and will not be discussed. Experimental results from coatings made using a 10 μm gap are displayed in FIG. 16.

At coating velocity of 1.00 cm/s, polydomain films are obtained (see FIG. 17), whereas at 2.00 cm/s, in the Landau-Levich regime, monodomain coatings with in-plane birefringence over centimeter length scales are achieved (see FIG. 14), consistent with the uniaxial alignment of nanorods. Ellipsometry confirmed the in-plane birefringence of these films as high as 0.027±0.001 at 633-1690 nm.

Cracks and grooves running along the coating direction appear for coatings exceeding a thickness of ˜1.69 μm. As observed in FIG. 14, cracks completely penetrate the film in the evaporative regime, and groove defects that partially penetrate the film were observed in the Landau-Levich regime. Similar cracks in nanoparticle coatings have been observed by others^{24, 26} and can be understood as follows: aligned nanorods densify during the drying process caused by capillary forces, and excess stress is released by crack formation along the rods' alignment direction with the lowest fracture resistance.³⁹,⁴⁰

For thinner coatings, striped patterns perpendicular to the flow direction appeared at coating velocities of 1.65 and 1.90 cm/s under POM (see FIG. 14). These patterns were also observed using interference microscopy as height undulations along the flow direction (see FIG. S5). The defects comprise periodic thickness variation within a continuous film, and stripes exhibit higher frequencies at an increasing velocity. These stripe defects are undesirable because they impair optical birefringence and transparency (see FIG. 16) presumably by disturbing the nanorod's uniaxial superstructure. The observed striped patterns are attributed to the stick-slip effect, which involves the accumulation of nanoparticles within the meniscus due their low diffusivity, followed by periodic dewetting of the solvent from the drying nanoparticle film.⁴¹ The stick-slip effect has been observed in other mineral liquid crystal coatings at insufficient shear rates.^{24, 26} The observation of periodic birefringent bands by POM are attributed to collective rod tumbling⁴²⁻⁴⁴ and the strong affinity of rods to the substrate.

Together, FIGS. 14 and 16 show that optical quality films, spanning centimeter dimensions, are obtained by blade-coating at a velocity of near 2.00 cm/s with a gap of 10 μm. These conditions are in the Landau-Levich regime, and the coating velocity is high enough to avoid stick-slip defects, yet slow enough to avoid longitudinal film cracking during drying.

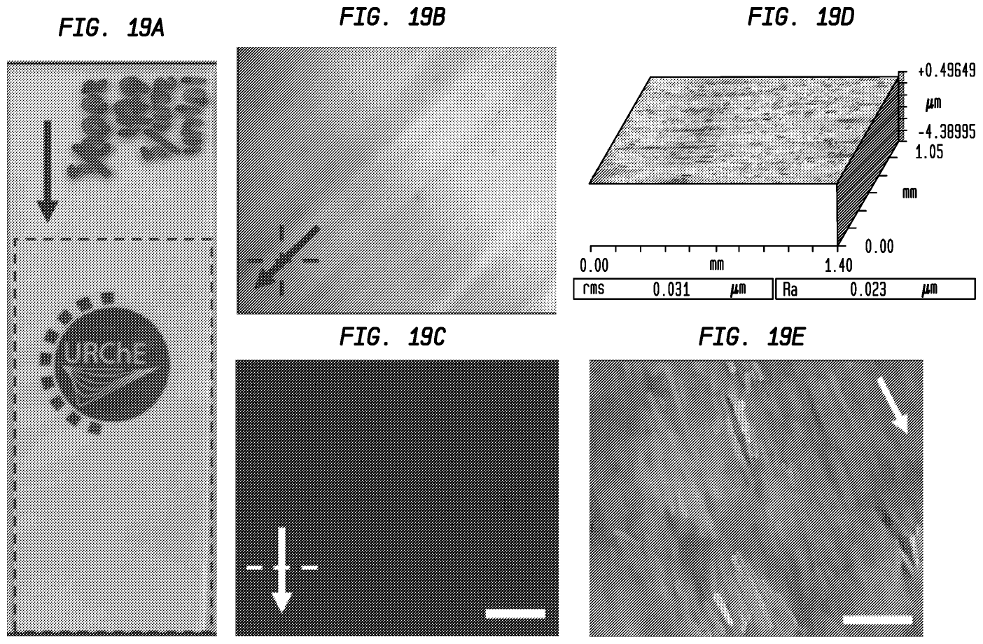

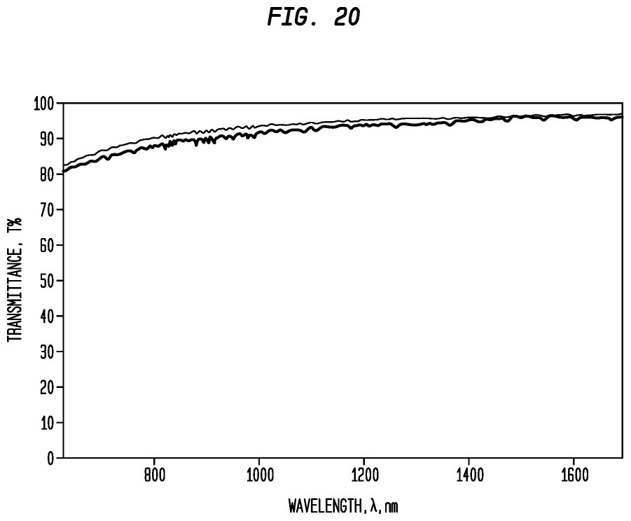

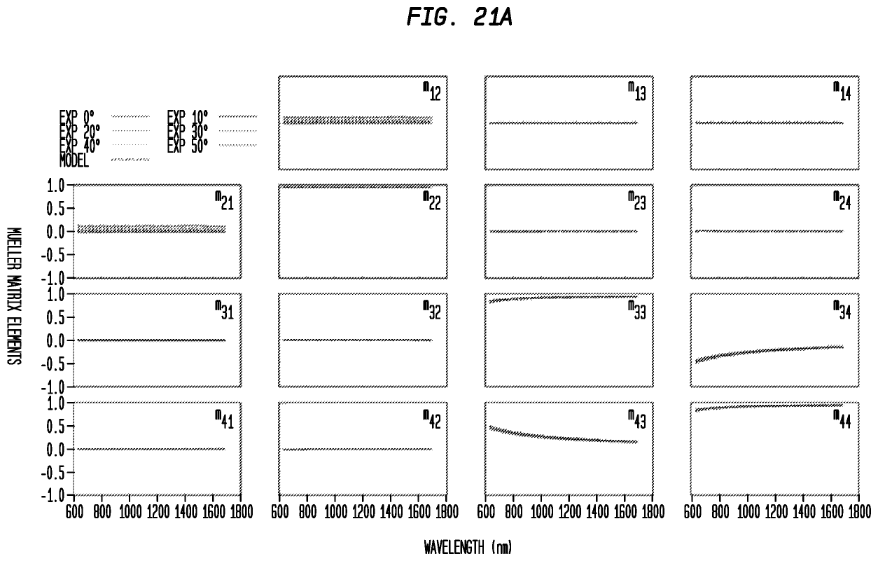

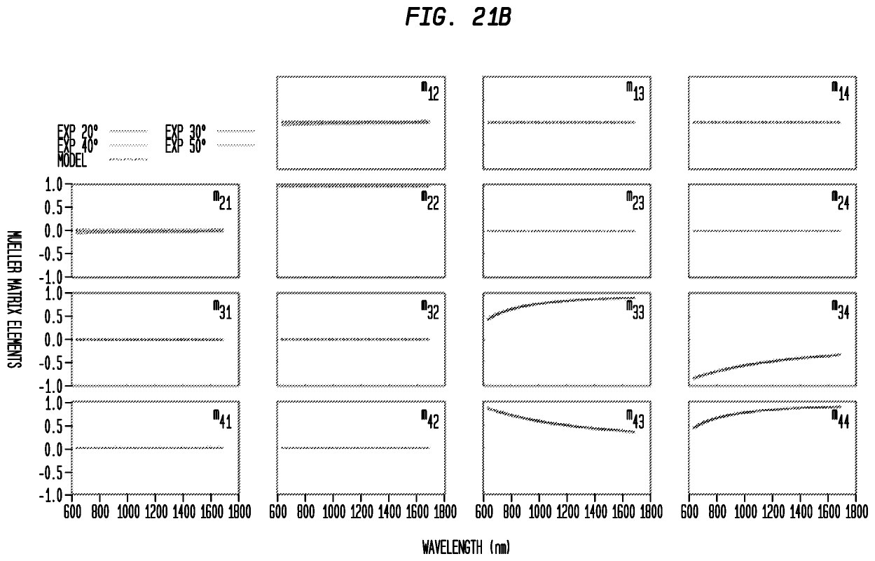

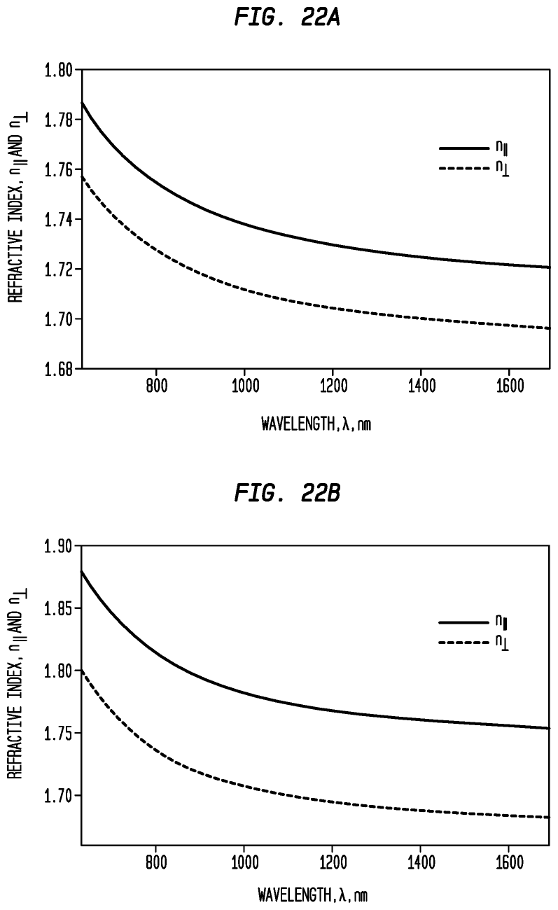

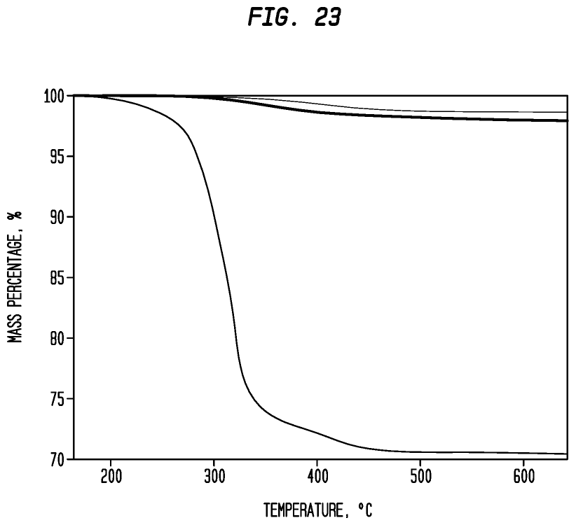

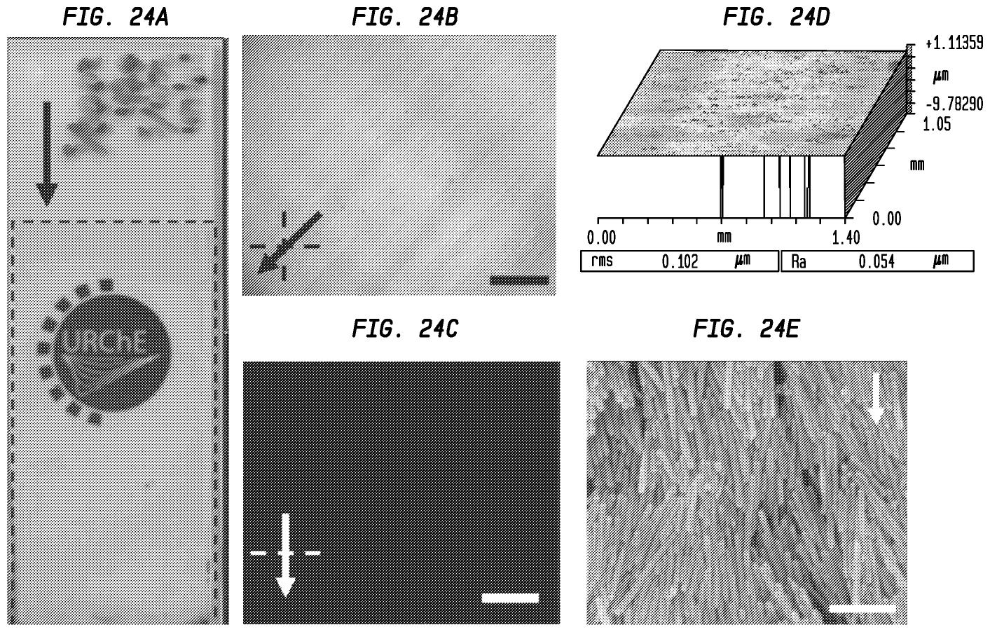

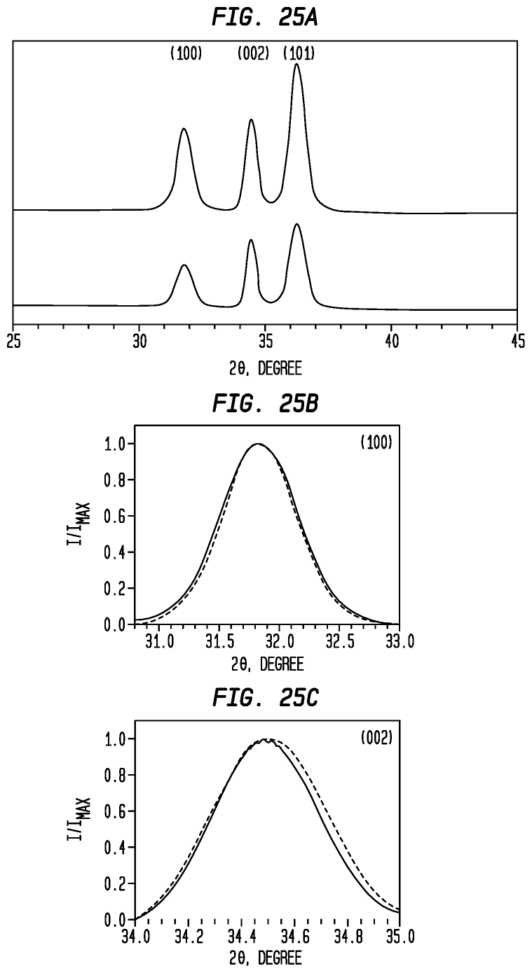

Optimized Blade Coating and Calcination. Crack-free nanorod films covering 5.0 cm×2.5 cm were reproducibly fabricated by blade coating at 2.00 cm/s followed by drying. One such film, displayed in FIG. 19, has a thickness of 1.66±0.01 μm. The film exhibits transmittance≥0.80 from 633 to 1690 nm (see FIG. 20) and exhibits uniform birefringence between crossed polarizers. In-plane birefringence was measured using Mueller Matrix spectroscopic ellipsometry (see FIG. 20-22) to be 0.027±0.001. Scanning white-light interferometry revealed high quality surface finish (FIG. 6d) with an average surface roughness of 23 nm. SEM imaging of the film's top surface, shown in FIG. 19, confirms that the densely packed, TODA-functionalized ZnO nanorods were successfully oriented along flow direction by blade-coating. The blade-coated nanorod film in FIG. 19 was calcined to remove organic ligands, resulting in a mesomorphic ceramic thin film. Thermogravimetric analysis confirms that organic ligands are completely removed after thermal treatment at 280° C. (see FIG. S9). A comparison of FIG. 24 to FIG. 19 indicates that the film's optical properties did not appreciably change following calcination. X-ray diffraction data (see FIG. 25) confirm that nanorods preserved their dimensions and crystallographic structure upon calcination, as anticipated.⁴⁵ The mesomorphic ceramic film retained transparency (see FIG. 24, FIG. 20), while its thickness reduced from 1.66±0.01 to 1.37±0.02 μm, due to the removal of TODA. The in-plane birefringence of the mesomorphic ceramic film is shown in FIGS. 20-22 at 0.075±0.002. Scanning white-light interferometry (FIG. 24d) indicates that the surface finish increases upon ligand removal to an average surface roughness of 54 nm. SEM imaging indicates that the ZnO nanorods dimensions and preferred orientation are unaffected by calcination (FIG. 24e).

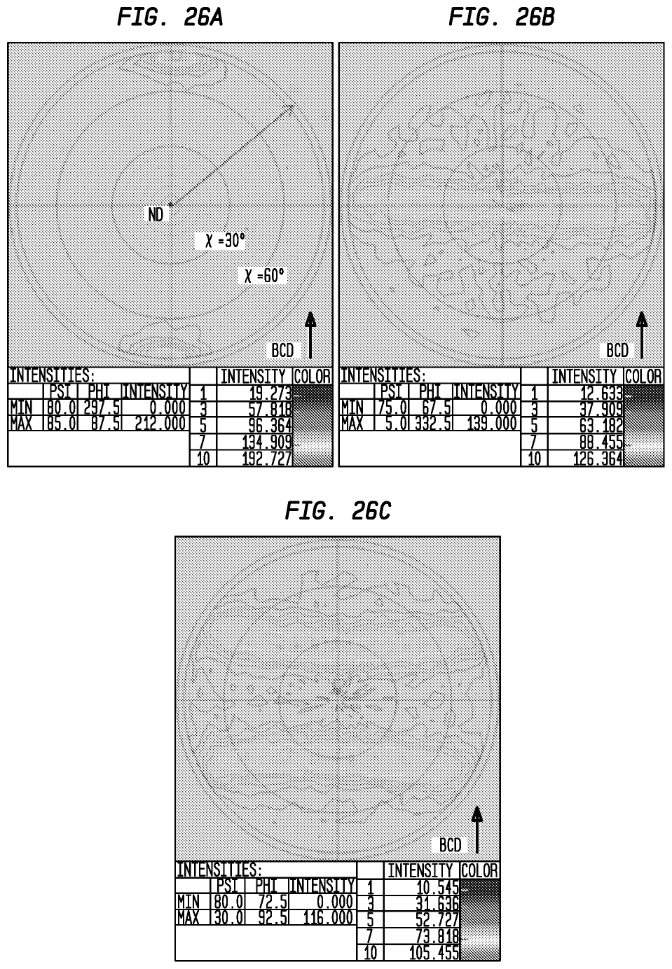

To evaluate the bulk orientation of ZnO crystalline planes relative to the blade-coating direction, XRD pole figures of mesomorphic ceramic films were collected. Resulting contour plots are shown in FIG. 26 to indicate the orientation distribution of designated crystallographic planes as a function of inclination (χ) and azimuthal angle (ϕ) in three dimensions. The intensity along the blade-coating direction (BCD) reveals that crystal's planes are tilted in the BCD, and the intensity along the transverse direction (TD) indicates that the crystal planes are rotated about the BCD. FIG. 26 shows that the [002] poles are preferentially oriented near ϕ=90° and χ=90°, thus the (002) planes lie normal to the BCD. Since the nanorod's long dimension is perpendicular to the (002) planes (FIG. 11b), the ZnO crystallites form a uniaxial superstructure along the flow direction. In contrast to the (002) poles, the (100) poles are widely distributed along the TD, perpendicular to the BCD. The lack of alignment of the (100) planes is attributed to free rotation during the assembly about the rods' long axes.⁴³ Similarly, the (101) pole density shows symmetry about both RD and TD that is also consistent with uniaxial alignment of rod with free rotation about the rods' long axes. The XRD pole figures provide strong evidence that uniaxial orientation of ZnO is present within the bulk phase of the mesomorphic ceramic, and such anisotropic morphology is the origin of large uniform birefringence.

The measured birefringence of the optimized blade-coated film (Δn=0.027±0.001) and the corresponding mesomorphic ceramic film (Δn=0.075±0.002) both exceed ZnO's intrinsic birefringence of 0.010±0.001. The high birefringence of blade-coated films fabricated here is attributed to a combination of intrinsic and form birefringence. Previous studies have confirmed that ligand removal upon calcination creates interparticle voids which enhance form birefringence.^{46, 47}

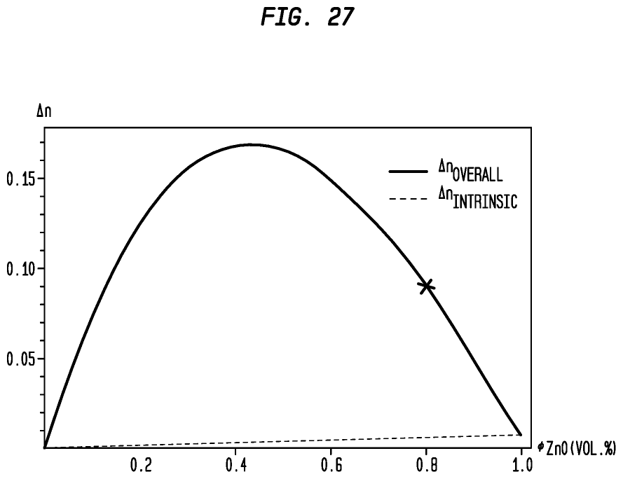

To evaluate the significance of form birefringence in the prepared films, Bruggeman's effective medium theory was applied to an idealized, heterogeneous material made of perfectly aligned ZnO nanorods filled with air.⁴⁸⁻⁵⁰ The model assumes monodisperse nanorods with an aspect ratio of 20 and refractive indices of nₑ=1.999 and nₒ=1.991. Results are shown in FIG. 27 as a plot of overall birefringence versus the volume fraction of ZnO, Φ_{ZnO}. The overall birefringence includes non-linear contributions from intrinsic and form birefringence and exhibits a maximum near Φ_{ZnO}˜0.5. The part of the overall birefringence that is attributable to intrinsic birefringence is depicted as a dashed line on the figure and was estimated by the product of Φ_{ZnO} and ZnO's native birefringence (nₑ−nₒ=0.008). The cross mark in the figure indicates the composition experimentally determined by fitting ellipsometry data at 633 nm on the overall birefringence curve. The emerging overall birefringence of 0.089 close to the measured birefringence of 0.081 at 633 nm, validates the high degree of rod alignment and the predominant role of form birefringence within the mesomorphic ceramic film. The important role of form birefringence, as expressed here, can guide subsequent materials processing steps, including sintering, to achieve robust waveplates for high power lasers.

Conclusions. In summary, a scalable process based on flow-directed nanoparticle alignment of a lyotropic nematic mesophase, followed by calcination, results in mesomorphic ceramic thin films. In contrast to inorganic waveplate manufacture using single crystals and GLAD sculptured films, the blade-coating method is cost-effective and can be scaled to large apertures. Furthermore, this process is expected to be broadly applicable to inorganic nanorods capable of forming lyotropic nematic phases. To suppress optical defects in flow-directed assembly, the blade-coating process can be optimized, leading to monodomain, uniaxially oriented films that are free from cracks. Defect-free films with quality surface finish were achieved by coating in the Landau-Levich regime. After calcination of optimized coatings, the uniaxial superstructure of ZnO crystallites was preserved over centimeter dimensions, giving rise to the smooth surface finish, optical transparency, and in-plane birefringence dominated by the form birefringence. The relationships established here between flow processing, film morphology, and optical birefringence provide a basis for further materials processing, such as thermal sintering, desired for high power laser, thin-film electronics, optoelectronics, and catalysis. Expected material trade-offs to occur during sintering include an improvement in mechanical properties through material densification, greater transparency through reduced pore size leading to less scattering, and a reduction in form birefringence as rods fuse together and begin to lose shape anisotropy.

Calcite nanorods can be used in place of or in addition to one or more of titanium dioxide, lanthanum phosphate, and zinc oxide. Calcite rods of like dimensions, in like dispersion or suspension, can be likewise coated on a substrate and sintered into a solid film with like desirable optical and other properties.

Although the foregoing has been described in some detail for purposes of clarity, it will be apparent that certain changes and modifications may be made without departing from the principles thereof. There can be many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

### LISTING OF REFERENCES—FIRST GROUP

1. Mitchell, K. J., Radwell, N., Franke-Arnold, S., Padgett, M. J. & Phillips, D. B. Polarisation structuring of broadband light. Optics express 25, 25079-25089 (2017).
2. Zhao, X. H., Yao, Y., Sun, Y. X. & Liu, C. Circle polarization shift keying with direct detection for free-space optical communication. J Opt Commun Netw 1, 307-312 (2009).
3. Xu, P. F. et al. Polarized light source based on graphene-nanoribbon hybrid structure. Opt Commun 395, 76-81 (2017).
4. Huang, L. et al. Power scaling of linearly polarized random fiber laser. IEEE J Sel Top Quant 24, 1-8 (2018).
5. Koike-Tani, M., Tani, T., Mehta, S. B., Verma, A. & Oldenbourg, R. Polarized light microscopy in reproductive and developmental biology. Mol Reprod Dev 82, 548-562 (2015).
6. Walther, J. et al. In vivo imaging of human oral hard and soft tissues by polarization-sensitive optical coherence tomography. J Biomed Opt 22, 121717 (2017).
7. Chen, H. M. P., Ou, J. J. & Chen, S. H. Glassy liquid crystals as self-organized films for robust optoelectronic devices. Nanosci Technol, 179-208 (2014).
8. Chen, S. H. et al. Circularly polarized light generated by photoexcitation of luminophores in glassy liquid-crystal films. Nature 397, 506-508 (1999).
9. Hawkeye, M. M. & Brett, M. J. Glancing angle deposition: Fabrication, properties, and applications of micro- and nanostructured thin films. J Vac Sci Technol A 25, 1317-1335 (2007).
10. Barranco, A., Borras, A., Gonzalez-Elipe, A. R. & Palmero, A. Perspectives on oblique angle deposition of thin films: From fundamentals to devices. Prog Mater Sci 76, 59-153 (2016).
11. Ikesue, A. & Aung, Y. L. Origin and future of polycrystalline ceramic lasers. IEEE J Sel Top Quant 24, 1-7 (2018).
12. Kitajima, S. et al. Yb³⁺-doped CaF₂—LaF₃ ceramics laser. Opt Lett 42, 1724-1727 (2017).
13. Geng, Y. H. et al. Origin of strong chiroptical activities in films of nonafluorenes with a varying extent of pendant chirality. J Am Chem Soc 125, 14032-14038 (2003).
14. Kato, T., Mizoshita, N. & Kishimoto, K. Functional liquid-crystalline assemblies: Self-organized soft materials. Angew Chem Int Edit 45, 38-68 (2006).
15. Cozzoli, P. D., Kornowski, A. & Weller, H. Low-temperature synthesis of soluble and processable organic-capped anatase TiO₂ nanorods. J Am Chem Soc 125, 14539-14548 (2003).
16. Kim, J., Peretti, J., Lahlil, K., Boilot, J. P. & Gacoin, T. Optically anisotropic thin films by shear-oriented assembly of colloidal nanorods. Adv Mater 25, 3295-3300 (2013).
17. Cheng, F. et al. Lyotropic ‘hairy’ TiO₂ nanorods. Nanoscale Adv 1, 254-264 (2019).
18. Hu, H. et al. In-plane aligned assemblies of 1D-nanoobjects: Recent approaches and applications. Chemical Society Reviews (2020).
19. Messing, G. L. et al. Texture-engineered ceramics-property enhancements through crystallographic tailoring. J Mater Res 32, 3219-3241 (2017).
20. Zhang, Z. et al. Preparation and anisotropic properties of textured structural ceramics: A review. J Adv Ceram 8, 289-332 (2019).
21. Meseck, G. R., Terpstra, A. S. & MacLachlan, M. J. Liquid crystal templating of nanomaterials with nature's toolbox. Current Opinion in Colloid & Interface Science 29, 9-20 (2017).
22. Dessombz, A. et al. Design of liquid-crystalline aqueous suspensions of rutile nanorods: Evidence of anisotropic photocatalytic properties. J Am Chem Soc 129, 5904-5909 (2007).
23. Zhang, Q. et al. Self-assembly and photocatalysis of mesoporous TiO₂ nanocrystal clusters. Nano Res 4, 103-114 (2011).
24. Deng, H. H., Zhang, H. & Lu, Z. H. Dye-sensitized anatase titanium dioxide nanocrystalline with (01) preferred orientation induced by langmuir-blodgett monolayer. Chem Phys Lett 363, 509-514 (2002).
25. Kawakita, M., Kawakita, J., Uchikoshi, T. & Sakka, Y. Photoanode characteristics of dye-sensitized solar cell containing TiO₂ layers with different crystalline orientations. J Mater Res 24, 1417-1421 (2009).
26. Sun, B. Q. & Sirringhaus, H. Surface tension and fluid flow driven self-assembly of ordered ZnO nanorod films for high-performance field effect transistors. J Am Chem Soc 128, 16231-16237 (2006).
27. Chang, Y. F., Watson, B., Fanton, M., Meyer, R. J. & Messing, G. L. Enhanced texture evolution and piezoelectric properties in cuo-doped CuO-doped Pb(In_{1/2}Nb_{1/2})O₃—Pb(Mg_{1/3}Nb_{2/3})O₃—PbTiO₃ grain-oriented ceramics. Appl Phys Left 111, 232901 (2017).
28. Kimura, T. Application of texture engineering to piezoelectric ceramics—a review. J Ceram Soc Jpn 114, 15-25 (2006).
29. Guang, M. et al. Controllable synthesis of transparent dispersions of monodisperse anatase-TiO₂ nanoparticles and nanorods. Mater Chem Phys 224, 100-106 (2019).
30. Dierking, I., Textures of liquid crystals. (Wiley-VCH Verlag, 2003), pp. 51-54.
31. Munier, P., Gordeyeva, K., Bergstrom, L. & Fall, A. B. Directional freezing of nanocellulose dispersions aligns the rod-like particles and produces low-density and robust particle networks. Biomacromolecules 17, 1875-1881 (2016).
32. Apetz, R. & van Bruggen, M. P. B. Transparent alumina: A light-scattering model. J Am Ceram Soc 86, 480-486 (2003).
33. Fujiwara, H., Spectroscopic ellipsometry: Principles and applications. (John Wiley & Sons, 2007).
34. Hilfiker, J. N. & Tiwald, T., in Spectroscopic ellipsometry for photovoltaics (Springer, 2018), pp. 115-153.
35. van Popta, A. C., Cheng, J., Sit, J. C. & Brett, M. J. Birefringence enhancement in annealed TiO₂ thin films. J Appl Phys 102(2007).
36. Jellison, G. E., Boatner, L. A., Budai, J. D., Jeong, B. S. & Norton, D. P. Spectroscopic ellipsometry of thin film and bulk anatase (TiO₂). J Appl Phys 93, 9537-9541 (2003).
37. Kim, J., Martinelli, L., Lahlil, K., Boilot, J P, Gacoin, T., Optomized combination of intrinsic and form birefringence if oriented LaPo₄ nanorod assemblies, Appl Phys Lett, 105, 061 102 (2014).

### LISTING OF REFERENCES—SECOND GROUP

1. Jacobs, S. D., Liquid-Crystals as Large Aperture Waveplates and Circular Polarizers. Proceedings of the Society of Photo-Optical Instrumentation Engineers 1981, 307, 98-105.
2. MacNally, S.; Smith, C.; Spaulding, J.; Foster, J.; Oliver, J. B., Glancing-angle-deposited silica films for ultraviolet wave plates. Appl. Optics 2020, 59 (5), A155-A161.
3. Grineviciute, L.; Buzelis, R.; Andrulevicius, M.; Lazauskas, A.; Selskis, A.; Drazdys, R.; Tolenis, T. In Advanced design of UV waveplates based on nano-structured thin films, Conference on Nanostructured Thin Films X, San Diego, Calif., August 9-10; Spie-Int Soc Optical Engineering: San Diego, Calif., 2017.
4. Jen, Y. J.; Wang, S. H.; Lin, C. F.; Lin, M. J. In Using a single anisotropic thin film as a phase retarder for oblique, Conference on Nanostructured Thin Films IV, San Diego, Calif., August 23-25; Spie-Int Soc Optical Engineering: San Diego, Calif., 2011.
5. Shao, J. D.; Wang, S. M.; Shen, Z. C.; Fu, X. Y.; He, H. B.; Fan, Z. X. In Glancing angle deposited thin films and their applications in laser systems, Annual Boulder Damage Conference on Laser Induced Damage in Optical Materials, Boulder, Colo., September 25-27; Spie-Int Soc Optical Engineering: Boulder, Colo., 2006.
6. Zhang, S. J.; Pelligra, C. I.; Feng, X. D.; Osuji, C. O., Directed Assembly of Hybrid Nanomaterials and Nanocomposites. Adv. Mater. 2018, 30 (18), 23.
7. Thiemann, S.; Gruber, M.; Lokteva, I.; Hirschmann, J.; Halik, M.; Zaumseil, J., High-Mobility ZnO Nanorod Field-Effect Transistors by Self-Alignment and Electrolyte-Gating. Acs Appl Mater Inter 2013, 5 (5), 1656-1662.
8. Cheng, F.; Verrelli, E.; Alharthi, F. A.; Das, S.; Anthopoulos, T. D.; Lai, K. T.; Kemp, N. T.; O'Neill, M.; Kelly, S. M., Solution-processable and photopolymerisable TiO(2)nanorods as dielectric layers for thin film transistors. RSC Adv. 2020, 10 (43), 25540-25546.
9. Rizzo, A.; Nobile, C.; Mazzeo, M.; De Giorgi, M.; Fiore, A.; Carbone, L.; Cingolani, R.; Manna, L.; Gigli, G., Polarized Light Emitting Diode by Long-Range Nanorod Self-Assembling on a Water Surface. ACS Nano 2009, 3 (6), 1506-1512.
10. Sun, Y. H.; Chen, L. M.; Bao, Y. F.; Zhang, Y. J.; Wang, J.; Fu, M. L.; Wu, J. L.; Ye, D. Q., The Applications of Morphology Controlled ZnO in Catalysis. Catalysts 2016, 6 (12), 44.
11. Mittal, M.; Furst, E. M., Electric Field-Directed Convective Assembly of Ellipsoidal Colloidal Particles to Create Optically and Mechanically Anisotropic Thin Films. Advanced Functional Materials 2009, 19 (20), 3271-3278.
12. Kim, J.; de la Cotte, A.; Deloncle, R.; Archambeau, S.; Biver, C.; Cano, J. P.; Lahlil, K.; Boilot, J. P.; Grelet, E.; Gacoin, T., LaPO4 Mineral Liquid Crystalline Suspensions with Outstanding Colloidal Stability for Electro-Optical Applications. Advanced Functional Materials 2012, 22 (23), 4949-4956.
13. Singh, A.; English, N. J.; Ryan, K. M., Highly Ordered Nanorod Assemblies Extending over Device Scale Areas and in Controlled Multilayers by Electrophoretic Deposition. J. Phys. Chem. B 2013, 117 (6), 1608-1615.
14. Zorn, M.; Tahir, M. N.; Bergmann, B.; Tremel, W.; Grigoriadis, C.; Floudas, G.; Zentel, R., Orientation and Dynamics of ZnO Nanorod Liquid Crystals in Electric Fields. Macromol. Rapid Commun. 2010, 31 (12), 1101-1107.
15. Pelligra, C. I.; Majewski, P. W.; Osuji, C. O., Large area vertical alignment of ZnO nanowires in semiconducting polymer thin films directed by magnetic fields. Nanoscale 2013, 5 (21), 10511-10517.
16. Zhang, S. J.; Pelligra, C. I.; Keskar, G.; Majewski, P. W.; Ren, F.; Pfefferle, L. D.; Osuji, C. O., Liquid Crystalline Order and Magnetocrystalline Anisotropy in Magnetically Doped Semiconducting ZnO Nanowires. ACS Nano 2011, 5 (10), 8357-8364.
17. Abecassis, B.; Lerouge, F.; Bouquet, F.; Kachbi, S.; Monteil, M.; Davidson, P., Aqueous Suspensions of GdPO4 Nanorods: A Paramagnetic Mineral Liquid Crystal. J. Phys. Chem. B 2012, 116 (25), 7590-7595.
18. Yang, P. D.; Kim, F., Langmuir-Blodgett assembly of one-dimensional nanostructures. ChemPhysChem 2002, 3 (6), 503-+.
19. Zhang, W. S.; Chen, S. H.; Hilfiker, J. N.; Anthamatten, M., Mesomorphic Ceramic Films Synthesized via Lyotropic Self-Assembly of Metal Oxide Nanorods Complete with Sintering. ACS Appl. Nano Mater. 2020, 3 (11), 10605-10611.
20. Cheng, F.; Verrelli, E.; Alharthi, F. A.; Kelly, S. M.; O'Neill, M.; Kemp, N. T.; Kitney, S. P.; Lai, K. T.; Mehl, G. H.; Anthopoulos, T., Lyotropic ‘hairy’ TiO2 nanorods. Nanoscale Adv. 2019, 1 (1), 254-264.
21. Zhang, S. J.; Majewski, P. W.; Keskar, G.; Pfefferle, L. D.; Osuji, C. O., Lyotropic Self-Assembly of High-Aspect-Ratio Semiconductor Nanowires of Single-Crystal ZnO. Langmuir 2011, 27 (18), 11616-11621.
22. Dessombz, A.; Chiche, D.; Davidson, P.; Panine, P.; Chaneac, C.; Jolivet, J. P., Design of liquid-crystalline aqueous suspensions of rutile nanorods: Evidence of anisotropic photocatalytic properties. J. Am. Chem. Soc. 2007, 129 (18), 5904-5909.
23. Srikantharajah, R.; Gerstner, K.; Romeis, S.; Peukert, W., Polarized Raman scattering and SEM combined full characterization of self-assembled nematic thin films. Nanoscale 2016, 8 (14), 7672-7682.
24. Srikantharajah, R.; Schindler, T.; Landwehr, I.; Romeis, S.; Unruh, T.; Peukert, W., From evaporation-induced self-assembly to shear-induced alignment. Nanoscale 2016, 8 (47), 19882-19893.
25. Zorn, M.; Meuer, S.; Tahir, M. N.; Tremel, W.; Char, K.; Zentel, R., Orientation of Polymer Functionalized Nanorods in Thin Films. J. Nanosci. Nanotechnol. 2010, 10 (10), 6845-6849.
26. Mittal, M.; Niles, R. K.; Furst, E. M., Flow-directed assembly of nanostructured thin films from suspensions of anisotropic titania particles. Nanoscale 2010, 2 (10), 2237-2243.
27. Kim, J.; Peretti, J.; Lahlil, K.; Boilot, J. P.; Gacoin, T., Optically Anisotropic Thin Films by Shear-Oriented Assembly of Colloidal Nanorods. Adv. Mater. 2013, 25 (24), 3295-3300.
28. Dierking, I.; Al-Zangana, S., Lyotropic Liquid Crystal Phases from Anisotropic Nanomaterials. Nanomaterials 2017, 7 (10), 28.
29. Sonin, A. S.; Churochkina, N. A.; Kaznacheev, A. V.; Golovanov, A. V., Mineral Liquid Crystals. Colloid J. 2017, 79 (4), 421-450.
30. Lekkerkerker, H. N. W.; Vroege, G. J., Liquid crystal phase transitions in suspensions of mineral colloids: new life from old roots. Philos. Trans. R. Soc. A-Math. Phys. Eng. Sci. 2013, 371 (1988), 20.
31. Voigt, M.; Klaumunzer, M.; Thiem, H.; Peukert, W., Detailed Analysis of the Growth Kinetics of ZnO Nanorods in Methanol. J Phys Chem C 2010, 114 (14), 6243-6249.
32. Lameche, N.; Bouzid, S.; Hamici, M.; Boudissa, M.; Messaci, S.; Yahiaoui, K., Effect of indium doping on the optical properties and laser damage resistance of ZnO thin films. Optik 2016, 127 (20), 9663-9672.
33. Schafer, S.; Srikantharajah, R.; Klaumunzer, M.; Lobaz, V.; Voigt, M.; Peukert, W., Self-alignment of zinc oxide nanorods into a 3D-smectic phase. Thin Solid Films 2014, 562, 659-667.
34. Li, L. S.; Walda, J.; Manna, L.; Alivisatos, A. P., Semiconductor nanorod liquid crystals. Nano Lett. 2002, 2 (6), 557-560.
35. Doumenc, F.; Salmon, J. B.; Guerrier, B., Modeling Flow Coating of Colloidal Dispersions in the Evaporative Regime: Prediction of Deposit Thickness. Langmuir 2016, 32 (51), 13657-13668.
36. Le Berre, M.; Chen, Y.; Baigl, D., From Convective Assembly to Landau-Levich Deposition of Multilayered Phospholipid Films of Controlled Thickness. Langmuir 2009, 25 (5), 2554-2557.
37. Berteloot, G.; Daerr, A.; Lequeux, F.; Limat, L., Dip coating with colloids and evaporation. Chem. Eng. Process. 2013, 68, 69-73.
38. Lau, C. Y.; Russel, W. B., Particle ordering in colloidal thin films deposited by flow-coating. Aiche J. 2014, 60 (4), 1287-1302.
39. Dugyala, V. R.; Lama, H.; Satapathy, D. K.; Basavaraj, M. G., Role of particle shape anisotropy on crack formation in drying of colloidal suspension. Scientific Reports 2016, 6.
40. Dufresne, E. R.; Corwin, E. I.; Greenblatt, N. A.; Ashmore, J.; Wang, D. Y.; Dinsmore, A. D.; Cheng, J. X.; Xie, X. S.; Hutchinson, J. W.; Weitz, D. A., Flow and fracture in drying nanoparticle suspensions. Phys. Rev. Lett. 2003, 91 (22), 4.
41. Frastia, L.; Archer, A. J.; Thiele, U., Modelling the formation of structured deposits at receding contact lines of evaporating solutions and suspensions. Soft Matter 2012, 8 (44), 11363-11386.
42. Marrucci, G., Rheology of Rodlike Polymers in the Nematic Phase with Tumbling of Shear Orientation. Rheol. Acta 1990, 29 (6), 523-528.
43. Forest, M. G.; Wang, Q., Monodomain response of finite-aspect-ratio macromolecules in shear and related linear flows. Rheol. Acta 2003, 42 (1-2), 20-46.
44. Ripoll, M.; Winkler, R. G.; Mussawisade, K.; Gompper, G., Mesoscale hydrodynamics simulations of attractive rod-like colloids in shear flow. J. Phys.-Condes. Matter 2008, 20 (40), 11.
45. Park, K.; Xi, J. T.; Zhang, Q. F.; Cao, G. Z., Charge Transport Properties of ZnO Nanorod Aggregate Photoelectrodes for DSCs. J Phys Chem C 2011, 115 (43), 20992-20999.
46. Kim, J.; Martinelli, L.; Lahlil, K.; Boilot, J. P.; Gacoin, T.; Peretti, J., Optimized combination of intrinsic and form birefringence in oriented LaPO4 nanorod assemblies. Appl. Phys. Lett. 2014, 105 (6), 5.
47. Bragg, W. L.; Pippard, A. B., The Form Birefringence of Macromolecules. Acta Crystallographica 1953, 6 (11-1), 865-867.
48. Golovan, L. A.; Kashkarov, P. K.; Timoshenko, V. Y., Form birefringence in porous semiconductors and dielectrics: A review. Crystallogr. Rep. 2007, 52 (4), 672-685.
49. Giordano, S., Effective medium theory for dispersions of dielectric ellipsoids. J. Electrost. 2003, 58 (1-2), 59-76.
50. Spanier, J. E.; Herman, I. P., Use of hybrid phenomenological and statistical effective-medium theories of dielectric functions to model the infrared reflectance of porous SiC films. Phys. Rev. B 2000, 61 (15), 10437-10450.
51. Yoshikawa, H.; Adachi, S., Optical constants of ZnO. Jpn. J. Appl. Phys. Part 1—Regul. Pap. Brief Commun. Rev. Pap. 1997, 36 (10), 6237-6243.

1. A method of manufacturing mesomorphic ceramic films that are mechanically robust and stable and are free-standing absent a substrate, comprising:
providing a dispersion or suspension comprising inorganic nanorods on a substrate;
blade-coating the suspension into a film at speeds 2 cm/s or less between the blade and the dispersion or suspension on the substrate, applying a shear force to said dispersion or suspension to thereby flow-assemble the nanorods in preferred directions and to control the film thickness; and
sintering the suspension into an optically anisotropic solid film that is mechanically robust and stable and is free-standing absent the substrate;
wherein said sintered film is transparent to light and has a selected consistent birefringence over a wavelength range of visible and infrared light.

2. The method of claim 1, in which said applying of a shear force to flow-assemble the nanorods and control film thickness comprises causing relative motion between the substrate, with said dispersion or suspension thereon, and a doctor blade spaced 10 μm or less from the substrate.

3. The method of claim 1, in which the providing step comprises providing nanorods that comprise at least one of titanium dioxide, lanthanum phosphate, zinc oxide, and calcite.

4. The method of claim 1, in which the providing step comprises providing nanorods that have anisotropic shapes that include at least one of rods and ellipsoids, with widths in the range of 10-50 nanometers and aspect ratios of 4 or more.

5. The method of claim 1, in which the providing step comprises functionalizing said nanorods.

6. The method of claim 4, further including calcination of said dispersion or suspension film before said sintering.

7. The method of claim 6, in which said calcination is at temperatures in the range of 300-550 degrees Centigrade.

8. The method of claim 1, in which said sintering takes place at temperatures in the range of 600-1,000 degrees Centigrade.

9. The method of claim 1, in which said nanorods are non-functionalized when in said dispersion or suspension film.

10. The method of claim 1, further including controlling a temperature profile of said sintering to achieve a selected balance between mechanical strength and optical birefringence of said solid film.

11. The method of claim 1, in which said forming and sintering causes said solid film to be 1 to 10 micrometers thick.

12. The method of claim 1, in which said forming and sintering causes said solid film to have a surface area of a square centimeter or more.

13. The method of claim 1, in which said forming and sintering causes said solid film to have a birefringence in the range of 0.015-0.40 over visible and near infrared light.

14. The method of claim 1, in which said forming and sintering causes said solid film to have an optical transparency exceeding 90 percent.

15. The method of claim 1, further comprising including an isotropic and volatile solvent in said dispersion or suspension.

16. The method of claim 1, in which said solid film exhibits total birefringence that greatly exceeds the native birefringence of said nanorods.

17. The method of claim 1, in which said nanorods in said dispersion or suspension are bare or attached with ligands.

18. A robust optical device polarizing light, comprising:
a sintered solid film of nanorods oriented in preferred directions;
wherein said solid film is optically anisotropic and is sufficiently mechanically robust and stable to be free-standing; and
wherein said sintered film is transparent to light and has a selected birefringence range over a selected wavelength range of the light.

19. The optical device of claim 18, wherein said solid film has a thickness in the range of 1-10 micrometers.

20. The optical device of claim 18, in which said solid film has an area of the order of a square cm or more.

21. The optical device of claim 18, in which said selected birefringence range is 0.015-0.40 over visible and near infrared light.

22. The optical device of claim 18, in which said nanorods have anisotropic shapes that include at least one of rods and ellipsoids, with widths in the range of 10-40 nanometers and aspect ratios of 4 or more.

23. The optical device of claim 18, in which said solid film has an optical transparency exceeding 90 percent.

24. The optical device of claim 18, in which said nanorods are ZnO.

25. The optical device of claim 18, in which said film exhibits total birefringence that greatly exceeds the native birefringence of said nanorods.

26. The optical device of claim 18, in which the nanorods comprise one or more of titanium dioxide, lanthanum phosphate, zinc oxide, and calcite.
